(19) United States
(12) Patent Application Publication
(10) Pub. No.: US 2024/0308060 A1
(43) Pub. Date: Sep. 19, 2024

(54) PASSIVE LUMBAR EXOSKELETON

(71) Applicant: IUVO S.R.L, Pontedera (PI) (IT)

(72) Inventors: Giulio PROFACE, Pontedera (PI) (IT); Matteo MOISE, Pontedera (PI) (IT); Giacomo GIUSFREDI, Pontedera (PI) (IT); Matteo BIANCHI, Pontedera (PI) (IT); Francesco GIOVACCHINI, Pontedera (PI) (IT)

(21) Appl. No.: 18/576,055

(22) PCT Filed: Jul. 5, 2022
(86) PCT No.: PCT/IB2022/056224

§ 371 Date: Jan. 2, 2024

Related U.S. Application Data
(60) Provisional application No. 63/218,708, filed on Jul. 6, 2021.

(51) Int. Cl. B25J 9/00; B25J 9/16

(52) U.S. Cl. CPC B25J 9/0006; B25J 9/161

(57) ABSTRACT

A passive lumbar exoskeleton for assisting an operator in exerting efforts includes a compensation device arranged to provide assistive forces at a hip joint of the operator and a human-machine interface configured to secure the compensation device to the operator. The compensation device comprises an assistive torque assembly with a thigh link rotatably connected thereto. The thigh link defines a thigh cuff engageable by the operator to impose resistive moments on the compensation device. The assistive torque assembly comprises extension and flexion stop surfaces to define an allowed degree of motion for the compensation device, a transparent range mechanism defining a range of motion wherein the operator can move about with no assistive forces applied, and an assistance regulation device arranged to adjust the degree of tension in an elastic mechanism.

### FIELD OF THE DISCLOSURE

The disclosure relates to an exoskeleton, particularly a passive lumbar exoskeleton, the exoskeleton supporting assistive devices adapted to augment an operator's performance, mitigate repetitive strain injuries, and/or assist in exerting forces.

### BACKGROUND

Workers in numerous settings are vulnerable to various occupational disease types, including overuse injuries, fatigue, and workplace accidents. A typical industrial disease includes overuse and strain resulting from biomechanical lumbar overload. Biomechanical lumbar overload can result from, for example, an operator lifting heavy-weighted items from the ground or from repeatedly lifting a moderate weight from the ground, mainly if the lifting is done with poor posture.

Biomechanical lumbar overload can also result from an operator bending or repeatedly stooping during work activities, such as a worker in an automobile manufacturing facility bending or stopping to work on the part of a vehicle that is low to or only accessible from the ground. Biomechanical lumbar overload may result in numerous and costly problems, including occupational diseases ranging from pain, muscle weakness, swelling, numbness, and restricted mobility of the back to debilitating pain and life-threatening accidents.

Low back pain is the primary cause of disability in individuals under the age of 50. It is most frequently associated with occupations requiring physical exertion resulting in acute injuries and cumulative stresses to the spinal anatomy. Other occupational diseases include degenerative cervical spine disease, discogenic low back pain, and spinal stenosis, to name a few, all of which can be exacerbated by poor posture and repetitive and/or arduous physical tasks.

Wearable industrial exoskeleton technologies can improve endurance and safety in industrial settings, increase industrial productivity, and prevent common workplace injuries by minimizing muscles' and tendons' overuse and preventing excessive stress on the spine and lower back. Exoskeletons can support and augment an operator during strenuous activities, including lifting, stooping, bending, squatting, and overhead work, to reduce employee fatigue and workplace injuries and improve precision and the speed of work tasks. Exoskeletons may be additionally valuable in repetitive and awkward activities. Assisted by an exoskeleton, operators can lift heavy objects safely and effortlessly with less effort, increasing productivity and accuracy by reducing muscle fatigue. Older workers with valuable experience and intuition may, through an exoskeleton, be able to work longer than they otherwise could in physically demanding or challenging jobs.

An exoskeleton may be arranged to transfer loads through the exoskeleton to the ground in standing or kneeling positions, allowing operators to use heavy tools as if they were weightless. The exoskeleton can be configured to move naturally with the body and adapt to different body types and heights. The exoskeleton can replicate the body's biomechanical movement, while a corresponding interface can enwrap or engage with the operator's body.

An exemplary exoskeleton is arranged for the lower body, including the trunk and thighs, by enhancing performance, such as by reducing forces at the lower back (e.g., torque on the spine and lower back produced when lifting or squatting) and enabling the operator to perform repeated lifts over an extended period, with less effort. The exoskeleton may help the operator lift objects and reduce physical risks and discomfort from tasks carried out by bending at the knees, hips, or waist.

It has been found that the lower body, trunk, and upper body regions could benefit from active and passive exoskeletons. Muscle-activity reductions have been reported as an effect of active and passive exoskeletons. Exoskeletons can potentially reduce the underlying factors associated with work-related musculoskeletal injury.

However, while certain exoskeletons are available, several technical issues hinder the practical and widespread use, adoption, and compliance of exoskeletons in the industry. Specific problems include discomfort for both passive and active exoskeletons, the device's weight, poor alignment with human anatomy and kinematics, and inability to detect human intention to enable smooth movement for active exoskeletons and case of use to ensure consistent and compliant service.

Another issue is ensuring that an exoskeleton's assistance is commensurate with the operator's particular needs and activities. Existing systems may provide static or dynamic assistive forces but require complex control and adjustment systems, adapting exoskeletons to different operators in subsequent shifts and to other tasks costly and impractical. Still, existing exoskeletons are insufficiently adaptable to the operators' specific dimensions, strengths, and tasks, leading to poor compliance and poor results across different operators.

Existing exoskeleton devices may be poorly adapted to allow an operator to perform unrelated tasks and be doffed if such tasks are to be comfortably and effectively executed. Accordingly, there is a need for conveniently and temporarily deactivated exoskeletons without removing the device.

Safety concerns further limit the widespread adoption and use of exoskeletons. As an exoskeleton can support the extension and flexion of an operator's joints, an operator can be injured through over-extension or over-flexion of joints due to the assistive forces provided by these devices. Similar concerns exist regarding damage to the exoskeletons themselves or non-operators, as tension stored in exoskeletons may be released suddenly when not in use, causing damage to the exoskeletons and their surroundings to be expensive to mitigate or repair. A need exists for safer and more straightforward to operate exoskeletons.

Another problem is the exoskeleton hinders an operator's normal activities. For example, the exoskeleton may make tasks as straightforward as walking difficult or cumbersome by engaging or providing torques even when not necessary or desired. Passive exoskeletons are further poorly adapted to the specific biomechanical requirements of different activities, such as bending vs. stooping.

Given the preceding, there is a need for an exoskeleton, particularly a passive exoskeleton, that facilitates compliant and consistent use by an operator while providing a necessary assistive torque in various desired motions and angles and according to a desired level of torque.

### SUMMARY

Exoskeleton embodiments of the disclosure, including passive or pseudo-passive exoskeletons, are advantageously configured for relieving a load on one or more joints, such as the lumbosacral or hip joint, for preventing injury, and for assisting an operator's effort. Thus, the present disclosure's embodiments improve the prior art solutions discussed above, particularly from ergonomics, effectiveness, safety, and convenience of use. In addition, the exoskeleton embodiments advantageously allow an operator to receive assistive torque from the exoskeleton at the desired level of torque.

According to an embodiment of the present disclosure, a passive lumbar exoskeleton comprises a human-machine interface configured to secure a frame and one or more actuators to an operator's body. The exoskeleton includes two actuators, one for each leg of the operator. Each actuator contains a spring-loaded mechanism for generating a torque proportional to a relative angle between the trunk and the operator's corresponding thigh.

An assistive force provided by the exoskeleton mimics the physiological force acting on the lumbar region of the operator when the operator is flexing the trunk (e.g., while handling an object). The level of assistive force is selectable by the operator. The exoskeleton is further advantageously configured not to provide assistive force outside a predetermined range. The operator can walk and perform other activities unrelated to particular work activities that require assistance without hindrance. The exoskeleton is further configured to allow an operator to disengage one or both actuators to move and operate freely when aid is not required.

Embodiments of passive lumbar exoskeletons described herein rely on the principle of a passive, assistive exoskeleton with a compensation device using an elastic mechanism arranged to generate a torque proportional to the relative angle of a joint such as an operator's hip joint. Thus, exoskeleton embodiments of the present disclosure mimic the physiological torque required by the human body to lift an object from a location below the waist of the operator, whether by bending (i.e., the operator's legs are substantially locked, and movement is mainly at the core), stooping (i.e., the operator's waist is substantially locked, and movement is mostly in the legs, as in “squatting”), or otherwise.

According to an embodiment, an exoskeleton is configured to be worn by an operator and assume a position corresponding to the operator's hip joint. The exoskeleton may comprise or be configured to cooperate with a human-machine interface configured to secure one or more components of an exoskeleton, such as a compensation device, in a position proximate to the hip joint of the operator. The compensation device carried or secured by the human-machine interface may be configured to compensate for resistive moments acting on the hip joint during the operator's efforts, such as efforts relating to lifting an object from the ground.

In an embodiment, the compensation device comprises at least one assistive torque assembly configured to produce an assistive torque about the first axis of rotation due to the movement of or about the hip joint of the operator. The assistive torque assembly may comprise a housing secured to the operator such that it is held stationary concerning the hip joint when worn by the operator. The compensation device also includes a thigh link rotatably connected to the assistive torque assembly. The thigh link is rotatable about the first axis of rotation corresponding to the operator's hip joint. The thigh link may define a thigh cuff engageable by the operator's thigh to produce resistive moments about the first axis of rotation.

The assistive torque assembly may further comprise a first rotatable member arranged to be brought into relative motion about the first axis of rotation due to movement of the hip joint of the operator, the first rotatable member having an engagement portion. An elastic mechanism may be attached at the first end to the engagement portion of the first rotatable member. The engagement member may be offset from the first axis of rotation by a distance defining a moment arm. The clastic mechanism is configured to impart the first axis of rotation a moment opposite the resistive moments generated by or transmitted through the thigh link and thigh cuff.

The assistive torque assembly is configured to facilitate or define a transparent range of motion. An operator may move without assistance from the exoskeleton, such as by walking, outside of which the exoskeleton assists, such as bending or stooping movements. The assistive torque assembly also comprises a transparent range mechanism defining a range of motion in an embodiment. The operator can move without engaging the assistive torque of the assistive torque assembly.

The transparent range mechanism may comprise a second rotatable member arranged relative to the first rotatable member of the assistive torque assembly such that the first and second rotatable members are mutually rotatable about the first axis of rotation, wherein the second rotatable member is secured to the thigh link and is configured to engage the first rotatable member and the clastic mechanism attached to it when the thigh link is rotated to a predetermined flexion angle and a predetermined extension angle relative to the assistive torque assembly.

The transparent range mechanism may further comprise one or more protrusions of the second rotatable member configured to engage with one or more pawls of the first rotatable member at the predetermined flexion angle or the predetermined extension angle, such that the first rotatable member engages the elastic mechanism when the thigh link is rotated beyond the predetermined flexion angle or the predetermined extension angle. The transparent range mechanism may include a selection shaft rotatable about the first axis of rotation and operable by a free mode switch to selectively disengage the one or more pawls of the first rotatable member to enable the second rotatable member to rotate freely about the first rotatable member without engaging the elastic mechanism at any angle.

According to an embodiment, an assistance regulation device is secured to a second end of the elastic mechanism and configured to adjust tension in the elastic mechanism to allow an operator to select a desired level of assistance. An operator may operate the assistance regulation device to adjust tension in the elastic mechanism by adjusting a distance between the first and second ends of the elastic mechanism. The assistance regulation device may comprise an assistance selection dial configured to manually rotate a cam, a surface profile of the cam defining a plurality of predefined features corresponding to tension settings for the assistance regulation device.

The cam is part of a cam assembly comprising the cam and an attached bracket that connects to a spring mount that supports or is secured to the second end of the elastic mechanism. As the cam is rotated between one of the pluralities of predefined features, which may be recesses or detents configured to receive, for example, a pin of the bracket, the cam assembly is configured to move the bracket and accordingly, the spring mount within the actuator housing relative to the first end of the elastic mechanism. The cam mechanism hereby provides different levels of assistive force selectable by the operator.

The plurality of predefined tension settings may correspond to predetermined distances between the first and second ends of the elastic mechanism. In an embodiment, the cam defines five distinct tension settings corresponding to five distinct assistance levels. Still, it will be appreciated that in embodiments, more or fewer assistance levels may be provided.

These and other present features, aspects, and advantages of the present disclosure will become better understood regarding the following description, appended claims, and accompanying drawings.

### BRIEF DESCRIPTION OF THE DRAWINGS

FIG. 1 illustrates a perspective view of an embodiment of an exoskeleton.

FIG. 2A illustrates a front view of an embodiment of an exoskeleton worn by an operator.

FIG. 2B illustrates the exoskeleton of FIG. 2A according to a lateral view.

FIG. 2C illustrates the exoskeleton of FIG. 2A according to a back view.

FIG. 3A illustrates the basic motion of lifting assisted by the exoskeleton embodiments.

FIG. 3B illustrates the physiological torque required by an operator during lifting.

FIG. 3C illustrates a force diagram of the basic motion of lifting in unaided operators compared to operators using an exoskeleton of the embodiments.

FIG. 3D illustrates the torque on the lower back with and without the exoskeleton.

FIG. 4A illustrates a perspective view of an embodiment of a compensation device.

FIG. 4B illustrates the compensation device of FIG. 4A with a cover removed to expose the components of an embodiment of an assistive torque assembly.

FIG. 4C illustrates the compensation device of FIG. 4B with resistive moments acting on the compensation device.

FIG. 4D illustrates a perspective view of another embodiment of a compensation device on a user.

FIG. 4E illustrates a perspective view of the compensation device in FIG. 4D.

FIG. 4F illustrates a side cross-sectional view of an embodiment of a transparent range mechanism in FIG. 4E.

FIG. 4G illustrates a cross-sectional view taken along line 4G-4G of the transparent range mechanism of FIG. 4F.

FIG. 5A illustrates a side cross-sectional view of an embodiment of a transparent range mechanism.

FIG. 5B illustrates a top cross-section view of the transparent range mechanism of FIG. 5A, wherein a hip joint of the operator is rotated in flexion.

FIG. 5C illustrates a top cross-section view of the transparent range mechanism of FIG. 5A, wherein a hip joint of the operator is rotated in extension.

FIG. 5D illustrates a detail view of an engagement pawl of the transparent range mechanism of FIG. 5A.

FIG. 5E illustrates a top cross-section view of the transparent range mechanism of FIG. 5A, wherein the transparent range mechanism is disengaged to allow full freedom of rotation.

FIG. 5F illustrates a top cross-section view of the transparent range mechanism of FIG. 5A, wherein the transparent range mechanism is engaged to limit the freedom of rotation.

FIG. 5G illustrates the range of motion of the transparent range mechanism of FIG. 5A when engaged and disengaged.

FIG. 5H illustrates an assistance profile of the exoskeleton in an engaged compared to a disengaged mode of operation of the transparent range mechanism.

FIGS. 6A-6D illustrate partial side views of an embodiment of a compensation device in various stages of operation corresponding to a squatting motion performed by an operator.

FIGS. 7A-7D illustrate partial side views of an embodiment of a compensation device in various stages of operation corresponding to a stooping motion performed by an operator.

FIG. 8 illustrates partial side views of an embodiment of a compensation device in various operation stages corresponding to an operator's squatting and stooping motions.

FIG. 9 illustrates a plot of exemplary output torques of an embodiment of a compensation device according to a joint angle of an operator.

FIGS. 10A-10B illustrate exemplary stopping functions of an embodiment of a compensation device, the stopping functions corresponding to maximum extension and flexion angles of a hip joint of an operator, respectively.

FIG. 11A illustrates a schematic view of an embodiment of an assistance regulation device at various exemplary operational configurations.

FIG. 11B illustrates in cutaway perspective view the embodiment of FIG. 11A.

FIG. 11C illustrates in plan view an assistive torque assembly of an exoskeleton according to the embodiment of FIG. 11A.

FIG. 11D illustrates in the cutaway plan view the assistive torque assembly of the embodiment of FIG. 11A.

FIG. 11E illustrates the assistive torque assembly according to another embodiment in the cutaway plan view.

FIG. 11F illustrates a plot of exemplary output torques according to the various exemplary operation configurations of the embodiment of FIG. 11A.

FIG. 12A illustrates a detail view of an embodiment of a degree-of-freedom chain worn by an operator.

FIG. 12B illustrates an embodiment of a compensation device.

FIG. 13A illustrates steps 1-6 of an exemplary method of securing an embodiment of an exoskeleton to an operator.

FIG. 13B illustrates steps 7-11 of an exemplary method of securing an embodiment of an exoskeleton to an operator.

The drawing figures are not necessarily drawn to scale. Instead, they are drawn to provide a better understanding of the components and are not intended to limit scope but to provide exemplary illustrations. According to the present disclosure, the figures illustrate exemplary configurations of a passive lumbar exoskeleton and features and sub-components thereof.

### DETAILED DESCRIPTION

A better understanding of different embodiments of the disclosure may be had from the following description read with the accompanying drawings in which reference characters refer to like elements.

While the disclosure is susceptible to various modifications and alternative constructions, certain illustrative embodiments are in the drawings described below. It should be understood; however, there is no intention to limit the disclosure to the specific embodiments disclosed, on the contrary, the invention covers all modifications, alternative constructions, combinations, and equivalents falling within the spirit and scope of the disclosure.

The references are provided merely for convenience and do not define the sphere of protection or the embodiments.

It will be understood that unless a term is expressly defined in this application to possess a described meaning, there is no intent to limit the meaning of such term, either expressly or indirectly, beyond its plain or ordinary meaning.

Any element in a claim that does not explicitly state “means for” performing a specified function or “step for” performing a specific function is not to be interpreted as a “means” or “step” clause as specified in 35 U.S.C. § 112.

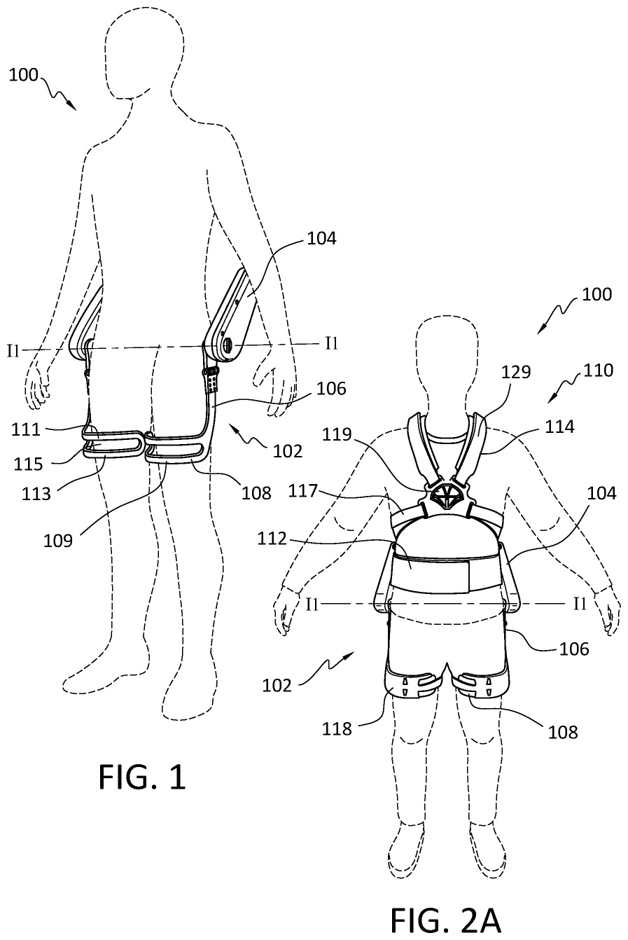

Referring to the embodiment of FIG. 1, a passive lumbar exoskeleton 100 is configured to be worn by an operator and to assume a position corresponding to a hip joint of the operator. The passive lumbar exoskeleton 100 comprises at least one compensation device 102 configured to compensate for resistive moments acting on the hip joint during an effort exerted by or movement of the operator. In addition, the compensation device 102 is configured to provide assistive forces to supplement the operator's actions, such as standing up from a bending or stooping position.

The compensation device 102 comprises at least one assistive torque assembly 104 configured to produce an assistive torque about the first axis of rotation I1 due to hip joint movement. In the depicted embodiment, left and right assistive torque assemblies 104 are provided at the left and right sides of the operator, respectively. The left and right assistive torque assemblies 104 may be provided at a corresponding location on the operator, for example, at the same height and proximate the operator's hip joints or offset each other as suitable.

The first axis of rotation I1 is configured to align or substantially align with the hip joint of the operator. The compensation device 102 also comprises a thigh link 106 connected to the assistive torque assembly 104, the thigh link 106 being rotatable about the first axis of rotation I1 and defining or cooperating with a thigh cuff 108 engageable by a thigh of the operator to produce resistive moments about the first axis of rotation I1. A frame 109 of the thigh cuff 108 extends primarily about the front side of the operator's thigh and may cooperate with a strap or other link (not shown) that connects to the frame 109 and extends about the back side of the operator's thigh to circumscribe the operator's thigh substantially completely and to provide assistive forces thereto.

The frame 109 comprises independent frame elements 111, 113 defining an aperture or space 115 therebetween. The frame elements 111, 113 may have a substantially similar shape or different shapes and configurations. By providing the independent frame elements 111, 113, the weight and bulk of the passive lumbar exoskeleton 100 and the cost of manufacturing the passive lumbar exoskeleton 100 may be reduced, and the assistive forces provided by the exoskeleton 100 may be more evenly distributed along the operator's thigh, improving the comfort of the operator. The frame 109 may be configured to cooperate with a liner for increased comfort.

While the frame of the thigh cuff 108 is shown as extending substantially about the front side of the operator's thigh and as having a bifurcated construction defining a gap or aperture between two frame components, it will be appreciated that any suitable construction and arrangement of the thigh cuff 108 and thigh link 106 may be utilized. For example, the frame of the thigh cuff 108 may extend primarily about the back side of the operator's thigh and may have a unitary construction or any other suitable configuration.

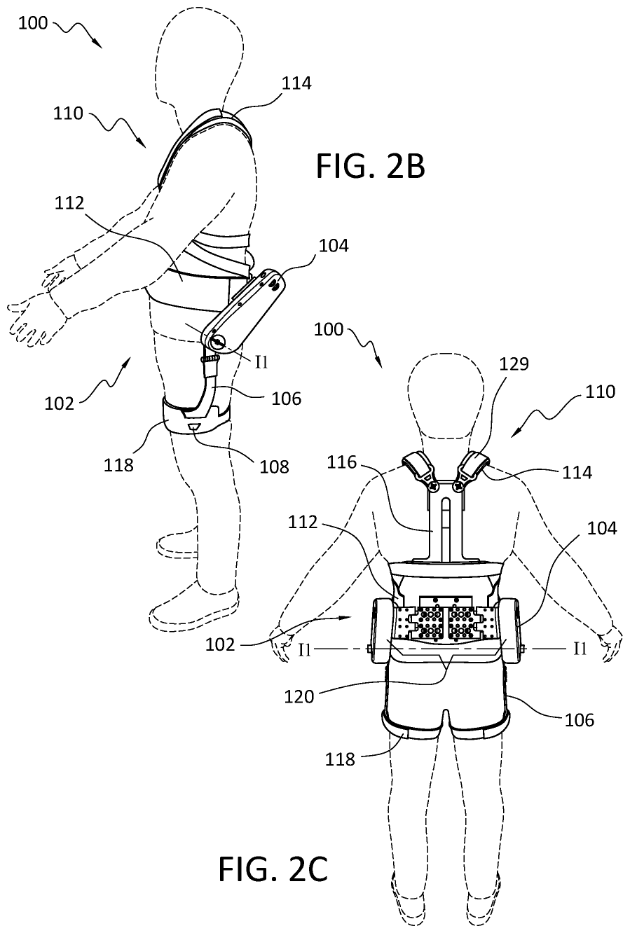

As illustrated in the embodiment of FIGS. 2A-2C, a human-machine interface 110 is configured to carry and secure the compensation device 102 in a position such that the first axis of rotation I1 corresponds and aligns or substantially aligns to the hip joint of the operator, such that the assistive torque assembly 104 is held stationary concerning the hip joint when worn and used by the operator. The human-machine interface 110 comprises a waist belt 112 wearable about the waist of the operator to secure the compensation device 102 in position relative to the operator's hip joint, an upper body harness 114 comprising at least one shoulder strap 129, and a thigh strap 118 configured to secure the thigh cuff 108 of thigh link 106 to the operator's thigh. The human-machine interface 110 may further comprise a liner extending about one or more rigid frame components, such as the assistive torque assembly 104 and the thigh link 106, to provide cushioning between the operator's skin and the components of the exoskeleton 100.

As shown in FIG. 2C, the upper body harness 114 comprises a back brace 116 configured to distribute forces exerted by the compensation device 102 due to the assistive torque produced by the assistive torque assembly 104 about the operator's body. The back brace 116 may connect via shoulder straps 129 and underarm straps 117 to an anterior connection component 119. The shoulder straps 129 and underarm straps 117 may connect to the back brace 116 and to the anterior connection component 119 by any suitable connection, including D-rings, buckles including side-release buckles or center-release buckles, rotatable brackets, magnetic buckles, cord locks, snap hooks, strap slides, combinations thereof, or any other suitable modality. In embodiments, the shoulder straps 129 and underarm straps 117 may have a different color and size and/or material relative to other straps for simplicity of donning the exoskeleton 100 by an operator.

The back brace 116, upper body harness 114, shoulder straps 129, underarm straps 117, the anterior connection component 119, and waist belt 112 may be or comprise a strut, straps, or other components such as those provided and described in U.S. Pat. No. 10,918,559, granted Feb. 16, 2021, U.S. Pat. No. 11,246,734, granted Feb. 15, 2022, or U.S. Pat. No. 9,220,625, granted on Dec. 29, 2015, are incorporated herein in their entirety by reference.

As shown, the exoskeleton 100 comprises a degree-of-freedom chain 120 arranged on a posterior side of the waist belt 112 and secured to and cooperating with the compensation device 102. The degree-of-freedom chain 120 is configured to partially enable movement of the compensation device 102 relative to the human-machine interface 110 and/or the operator's body in at least one degree of freedom. For example, the degree-of-freedom chain 120 may facilitate medial-lateral translation of one or both of the assistive torque assemblies 104 to conform to an operator's particular dimensions.

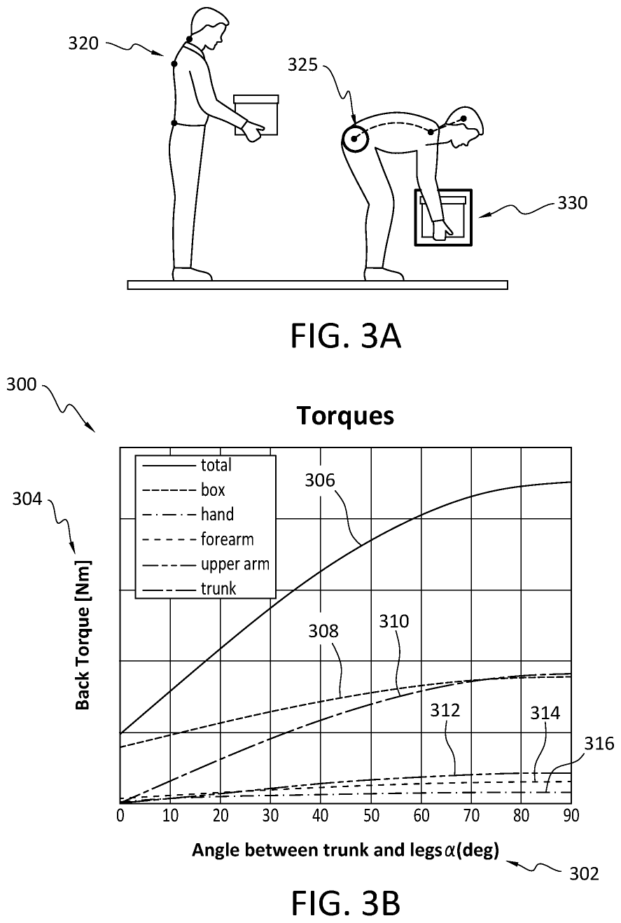

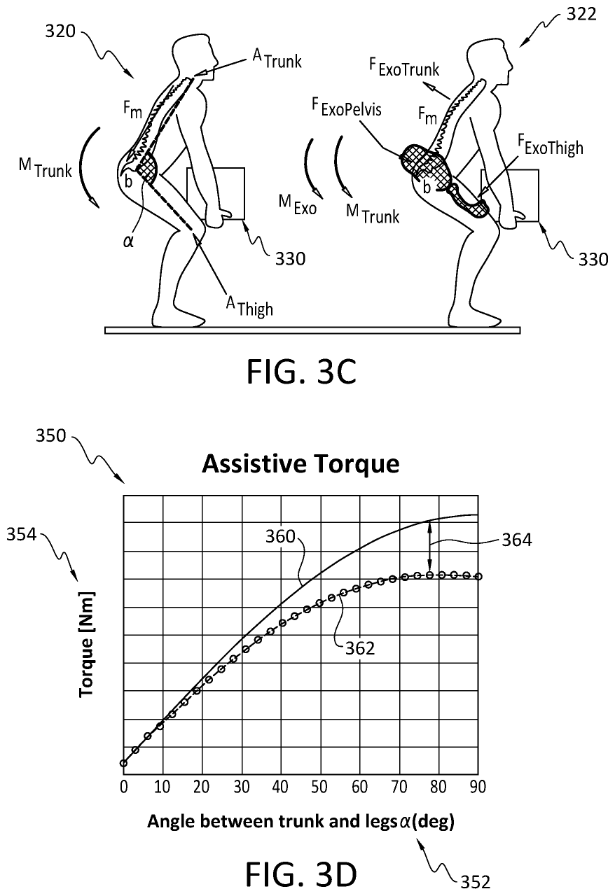

Referring to FIGS. 3A-3D, the compensation device 102 is configured to produce assistive moments when the effort exerted by or movement performed by the operator 320 comprises, for example, standing from a squatting position or stooping position while lifting an object 330. The assistive moments substantially emulate the natural biomechanical moments experienced by an operator 320 when lifting an object 330 from the ground or otherwise bending or stooping, as shown generally in FIG. 3A. As shown in the graph 300 of FIG. 3B, various torques 306, 308, 310, 312, 314, 316 are imparted upon the lumbosacral joint 325 when an operator 320 lifts an object 330 from the ground.

The torques 306, 308, 310, 312, 314, 316 imparted can be particularly detrimental to the lower back and spine of the operator, particularly if the torques 306, 308, 310, 312, 314 are imparted without the assistive moments of a passive lumbar exoskeleton of the depicted embodiments. For example, the torques 306, 308, 310, 312, 314, 316 of an unaided person, correspond respectively to a total torque, an object torque, a trunk torque, an upper arm torque, a forearm torque, and a hand torque, when measured as a function of back-torque 304 relative to the angle defined between the trunk and the leg 302, can result in a lower back joint (i.e., the lumbosacral joint) torque M_{Trunk} of 225 Nm for a 10 kg load lifted by a 75 kg person with a height of 175 cm, as shown in FIG. 3C.

As shown in FIG. 3D, embodiments of exoskeletons disclosed herein, such as a passive lumbar exoskeleton, alleviate the torques imparted on the lumbosacral joint 325 during lifting and other movements by imparting an assistive moment about the lumbosacral joint 325 and in the same or substantially the same direction as the biomechanical moment being exerted by the operator. Exoskeletons described herein impart an assistive moment about the lumbosacral joint by exerting respective forces on the trunk, thigh, and pelvis of the operator 320.

For example, the exoskeleton embodiments may advantageously reduce a lower back joint torque M_{Trunk} by applying one or more forces to the operator's body. The forces may include a force applied to the pelvis F_{ExoPelvis} proximate or by the waist belt 112, a force applied to the thighs F_{ExoThigh} proximate or by the thigh cuff 108, and a force applied to the trunk F_{ExoTrunk} proximate or by the anterior connection component 119 of the human-machine interface 110. These forces together generate an extension torque M_{Exo} that relieves vertebral compression Fₘ, as seen in the reduction between the operator 320 lifting the object 330 without the benefit of a passive lumbar exoskeleton relative to the operator 322, for whom the vertebral compression Fₘ is reduced.

As seen in graph 350 of FIG. 3D, the torque 360 on the lower back without an exoskeleton according to the embodiments, measured, for example, in Nm on the axis 354 is substantially higher over virtually the entire range 352 of angles of flexion and extension between the trunk and the leg relative to a corresponding torque 362 on the lower back with the assistance of an exoskeleton as described. The exoskeleton embodiments of the disclosure reduce the torque on the lower back by an amount of torque 364 proportional to an angle α between axes A_{Thigh} and A_{Trunk} corresponding to the thigh and the trunk of an operator respectively, as shown in FIG. 3C.

Thus, in an embodiment, the assistive torque 364 provided by the passive lumbar exoskeleton 100 increases as the angle between the axis of the thigh and the axis of the trunk increases up to a maximum amount of assistive torque 364 provided at the greatest angle between the thigh and trunk axes, for example at 90°. The increase in torque may be linear or non-linear as suitable. This advantageously enables the passive lumbar exoskeleton to provide the greatest assistance to the operator, and the greatest reduction at the moment on the lower back of the operator, at the most-advantageous moment, e.g., when the operator first commences to pick up an object from the ground, whether by bending or stooping. The assistive torque may taper off as the operator nears a standing position. This advantageously provides torque at the moment of greatest effort by the operator and greatest strain on the operator's lower back while reducing the assistance level near the standing position to imitate the operator's natural movements.

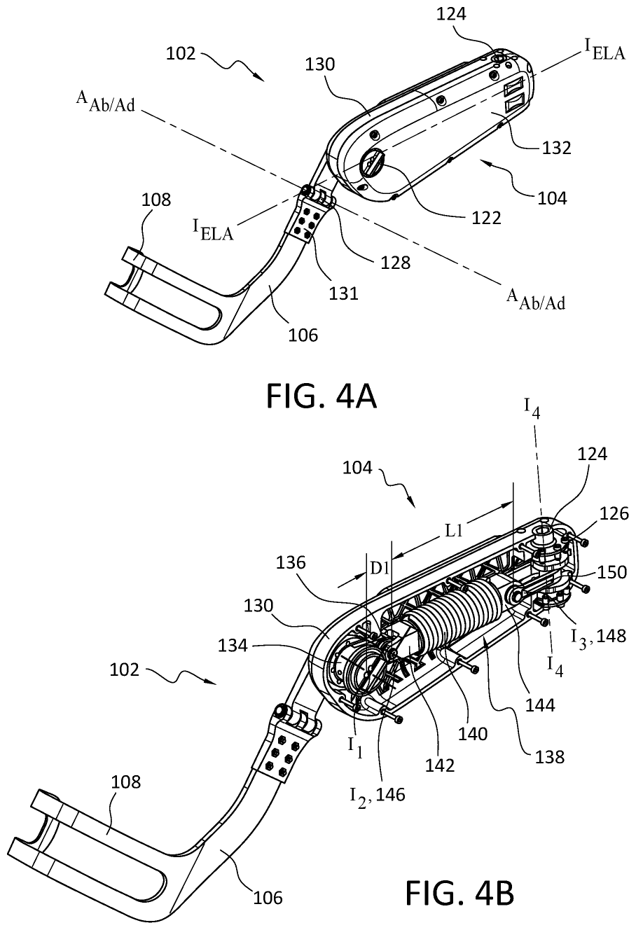

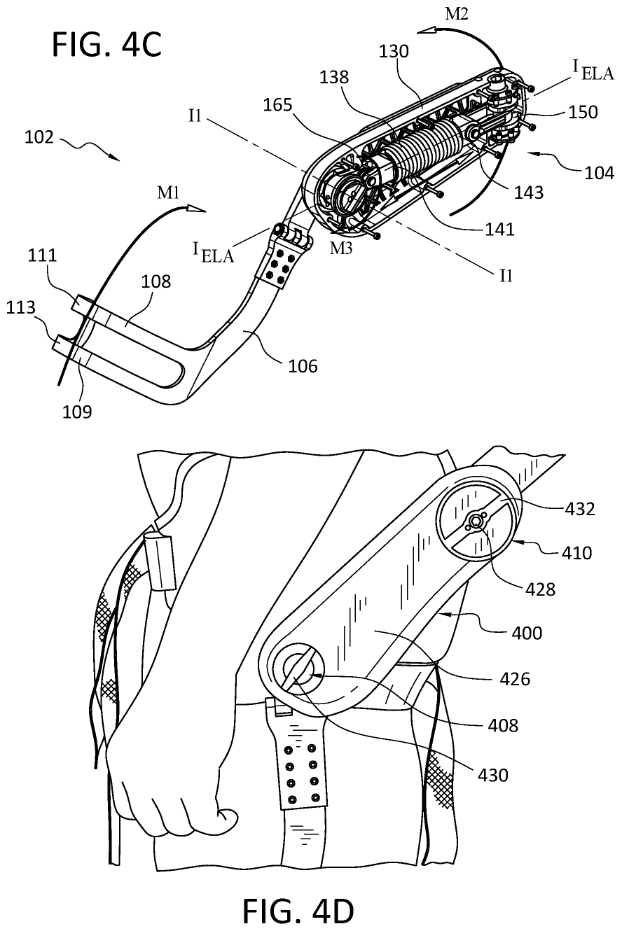

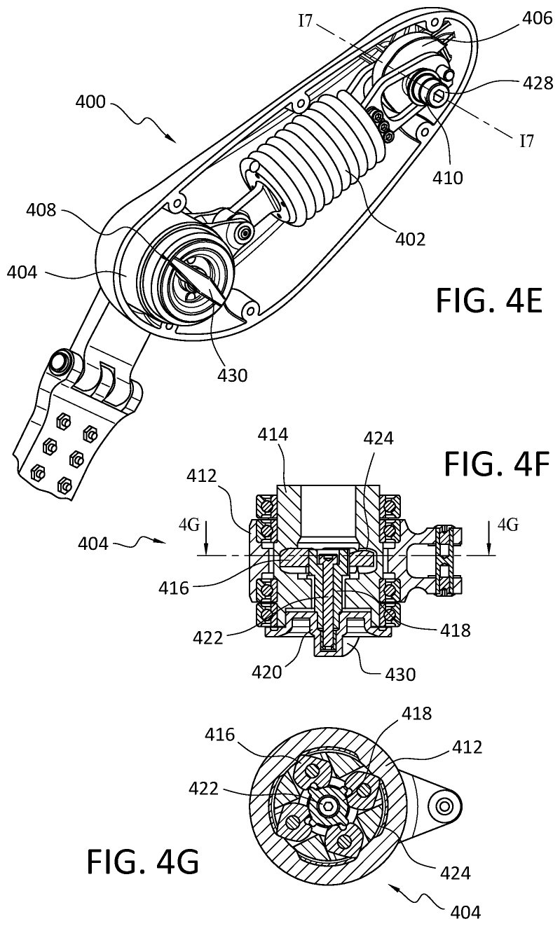

Turning now to FIGS. 4A-4C, an exemplary assistive torque assembly or torque generator box 104 of a compensation device 102 is shown and described. The assistive torque assembly 104 comprises a housing 130 defining any suitable configuration, such as an elongate configuration that extends along an axis I_{ELA}. The compensation device 102 includes a free mode switch 122 configured to disengage the assistive torque assembly 104 to disable the provision of assistive torque in response to resistive moments.

As illustrated, the compensation device 102 also comprises an assistance selection dial 124 configured to adjust a level of assistive torque output of the assistive torque assembly 104. According to the illustrated embodiment, the thigh link 106 is attached to the assistive torque assembly 104 via a connection element 128. The connection element 128 defines a hinge facilitating abduction/adduction motions about an axis A_{Ab/Ad}, this allowing the exoskeleton 100 to closely fit and conform to an operator and the operator's movements. The connection element 128 may comprise a bracket attached to the thigh link 106 by one or more fasteners 131. The fasteners 131 may be any suitable fastener such as screws, bolts, adhesives, or otherwise. The connection element 128 and the thigh link 106 are integrally formed in embodiments.

The housing 130 of the assistive torque assembly 104 is configured to carry each sub-component of the assistive torque assembly 104 and comprises a cover 132 configured to cover the sub-components carried by the housing 130 and protect them from the elements and tampering. The housing 130 may be arranged to minimize the profile of the exoskeleton 100, such that the operator is less likely to bump into objects while using the exoskeleton. The housing 130, the thigh link 106, and the connection element 128 may be formed from any suitable material, such as aluminum, stainless steel, carbon fiber, polymeric materials, combinations thereof, or any other suitable material.

As shown in FIG. 4B, the compensation device 102 is secured to the operator. The assistive torque assembly 104 is fixed relative to and aligned or substantially aligned to the hip joint of the operator, and the thigh link 106 is fixed relative to the thigh of the operator. Accordingly, rotation of the thigh of the operator about the hip joint results in a corresponding rotation of the thigh link 106 relative to the assistive torque assembly 104 about the first axis of rotation I1, whereas rotation of a torso or trunk of the operator about the hip joint results in a corresponding rotation of the assistive torque assembly 104 relative to the thigh link 106 about the first axis of rotation I1.

As illustrated, a moment M1 is produced when the operator performs a squatting motion, the squatting motion rotating the thigh cuff 108 and the thigh link 106 about the first axis of rotation I1 concerning the assistive torque assembly 104. Similarly, a moment M2 is produced when the operator performs a stooping motion, the stooping motion rotating the assistive torque assembly 104 about the first axis of rotation I1 concerning the thigh link 106 and the thigh cuff 108.

The compensation device 102 is configured to provide a moment M3 when the operator squats or stoops from a standing position, which rotates the assistive torque assembly 104 and the thigh link 106 relative to each other. The moment M3 may be converted into assistive torque by an elastic mechanism 138, in embodiments an extension spring that is engaged within the assistive torque assembly 104 as the operator returns to a standing position. That is, the moment M3 extends and stresses the elastic mechanism 138 through the work done by the operator bending or stooping and consequently rotating the assistive torque assembly 104 and the thigh link 106 relative to each other.

As a result, upon returning to the exoskeleton's standing orientation, mechanical energy stored in the prestressed elastic mechanism 138 is released to generate the assistive torque about the first axis of rotation I1. In particular, the assistive torque exerts a moment on the thigh cuff 108 and consequently against the thigh of the operator. In contrast, the operator moves from a squatting or stooping position to a standing position. As the assistive torque is applied against the thigh of the operator, the torque is likewise applied against the operator's trunk (such as via the anterior connection element and the waist belt) as shown in FIG. 3C. This advantageously reduces loads at the operator's lower back.

While the clastic mechanism 138 may be or comprise an extension spring, it will be appreciated that any suitable modality may be used. For example, the elastic mechanism 138 may comprise a compression spring, a torsion spring, an elastic wire, combinations thereof, or any other suitable component. The elastic mechanism 138 may be configured to cooperate with one or more of the components mentioned above to provide an assistive torque.

As illustrated in FIG. 4C, the assistive torque assembly 104 comprises a first rotatable member 134 configured to be brought into relative motion about the first axis of rotation I1 as a result of resistive moments of the operator relative to the hip joint. The first rotatable member 134 may be a substantially cylindrical rotating component. The first rotatable member 134 comprises an engagement portion 136 offset from the first axis of rotation I1 by a distance DI. The engagement portion 136 is connected to a first end 141 of the elastic mechanism 138 to impart a moment opposite the resistive moment of the operator on or through the first axis of rotation I1. The assistive torque assembly 104 further comprises an assistance regulation device 126 connected at a second end 143 of the clastic mechanism 138 for adjusting tension in the elastic mechanism 138 by adjusting a distance L1 between the first and second ends 141, 143 thereof in a resting configuration.

That is, the assistance regulation device 126 determines the distance L1 in a standing position and a corresponding base level of loading in the spring; as the operator moves in stooping or bending movements, the distance L1 increases proportionally to the angle between the thigh and the trunk of the operator, increasing the loading in the spring. Thus, by utilizing the assistance regulation device 126 to increase the distance L1 corresponding to a standing position, the amount of loading and assistive torque the exoskeleton provides during use increases.

In an embodiment, the elastic mechanism 138 comprises at least one elastic element 140 tensioned between first and second bracket assemblies 142, 144, with a length of the at least one clastic element 140 configured to be adjusted by linear movement provided by the assistance regulation device 126. As described above, the at least one elastic element 140 may be any suitable material and configuration, including springs, elastic wires, combinations thereof, or otherwise.

The first bracket assembly 142 is secured to the engagement portion 136 of the first rotatable member 134 by a first pivot pin 146 such that the first bracket assembly 142 pivots about a second axis of rotation 12 as the engagement portion 136 rotates about the first axis of rotation I1. The second axis of rotation 12 may be fixed relative to the engagement portion 136. The second axis of rotation 12 mutually rotates about the first axis of rotation I1 with the engagement portion 136.

The arrangement of the first bracket assembly 142 about the engagement portion 136 allows the rotation of one or more components of the exoskeleton 100 about the first axis of rotation I1 to effect a change in the distance L1 and serves to load and unload the elastic element 140. The loading and unloading of the clastic element 140 with rotation of the thigh link 106 relative to the assistive torque assembly 104 advantageously provide an assistive torque to aid an operator in standing and lifting from a stooping or bending position.

The second bracket assembly 144 is secured to a linkage assembly 150 of the assistance regulation device 126 with a second pivot pin 148. The second bracket assembly 144 pivots about a third axis of rotation 13, as the first bracket assembly 142 rotates about the first axis of rotation I1. The third axis of rotation 13 is fixed relative to the first axis of rotation I1. The third axis of rotation 13 allows the elastic element 140 to pivot, and the axis I_{ELA} to pivot, as the first bracket assembly 142 pivots about the first rotatable member 134 during the use of the exoskeleton 100.

FIGS. 4D and 4E illustrate another embodiment of a compensation device 400, functioning similarly to the compensation device of FIG. 4A. The compensation device 400 includes an elastic element 402, a transparent range mechanism 404, an assistance regulation device 406, a free mode switch 408, and an assistance selection dial 410. For example, the assistance selection dial 410 has an axis I7-I7 generally oriented perpendicularly to the axis 14-14 in FIG. 4B and offers an orientation that permits adjustment about the face of the compensation device, rather than a side of the compensation device in FIG. 4A. This orientation allows for easier manufacturability by simplifying construction.

As illustrated in FIG. 4D, the cover 426 encloses the compensation device 400, which includes knobs 430, 432 for the free mode switch 408, and assistance selection 410, respectively. The knobs 430, 432 are exposed to enable the user to manually adjust the compensation device without opening the cover or a tool. Of note, the knob 432 may be removed and/or is coaxial with a hole 428 for a key, such as a hole defined for receiving an allen key.

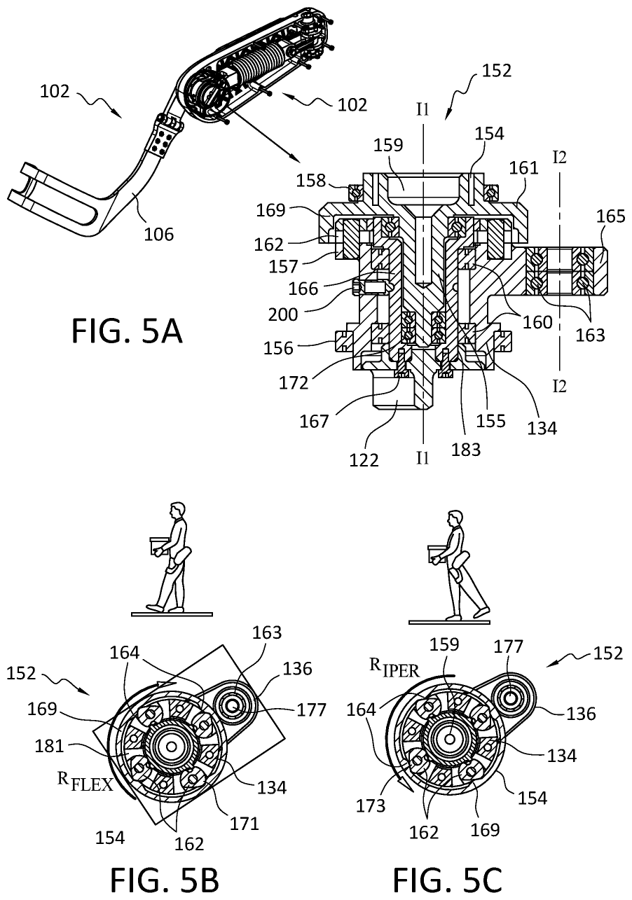

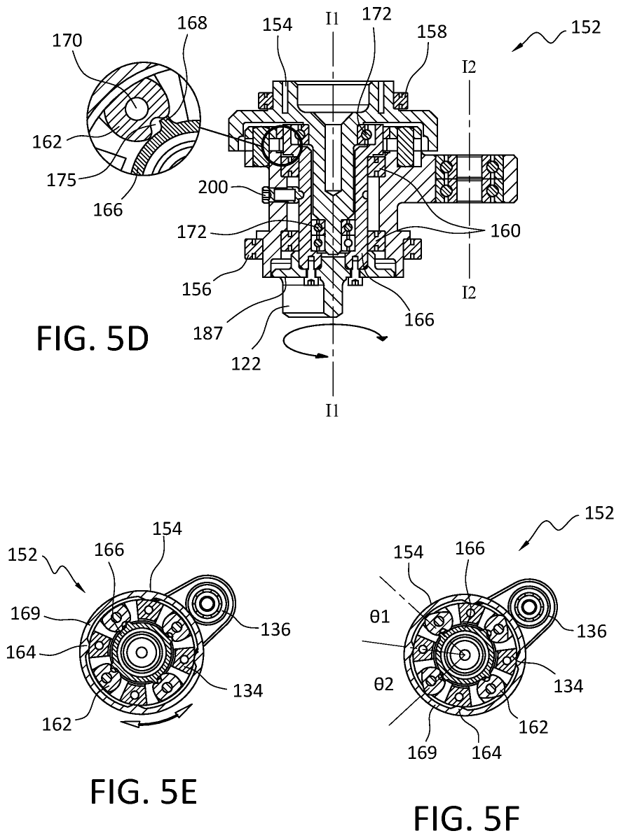

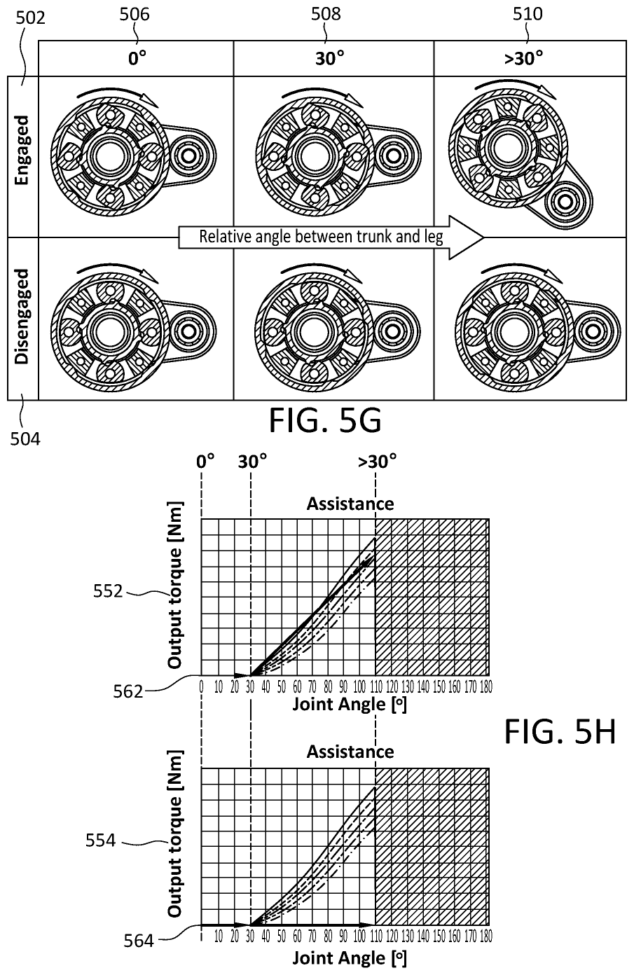

FIGS. 4F and 4G depict the transparent range mechanism 404 of the compensation device 400, which functions similarly to the transparent range mechanism of FIGS. 5A-5G yet is modified to reduce weight and encumbrance to the user, with improved manufacturability. The transparent range mechanism 404 includes a first rotatable member 412 and a second rotatable member 414. A series of pawls 416 are engageable with an engagement ring 424 located within the peripheries of the first and second rotatable members 412, 414. A shaft 418 carries the pawls 416, with a coaxial pin 422 and rotatable within and relative to a seat 420. The pawls 416 selectively engage the engagement ring 424 either formed within or by the second rotatable member 414, and functions similarly to the protrusions 164 in the embodiment of FIGS. 5B and 5C.

Turning now to FIGS. 5A-5G, the assistive torque assembly 104 comprises a transparent range mechanism 152 defining a range of motion in which the operator can move freely while wearing the exoskeleton 100, such as by walking with the exoskeleton 100 donned, without engaging the assistive torque assembly 104. This is particularly advantageous as it allows the operator to move without hindrance in normal activities while still automatically benefitting from the assistive torque provided by the exoskeleton 100 when performing pertinent activities, such as bending or stooping down to perform a task.

The transparent range mechanism 152 comprises a second rotatable member 154 arranged coaxially with the first rotatable member 134. The first and second rotatable members 134, 154 are mutually rotatable about the first axis of rotation I1. The second rotatable member 154 is non-rotatably secured to the thigh link 106 and is configured to engage the first rotatable member 134 when the thigh link 106 is rotated relative to the assistive torque assembly 104 to or beyond a predetermined flexion angle θ1 and/or to or beyond a predetermined hyperextension or extension angle θ2 (see FIG. 5F) relative to an initial position of the assistive torque assembly 104.

Accordingly, the movement of the thigh link 106 relative to the assistive torque assembly 104 and vice versa is transmitted through the second rotatable member 154. The second rotatable member 154 may extend through an aperture (not shown) defined through at least a part of a thickness of the housing 130 to connect to the thigh link 106. The second rotatable member 154 may define within a center thereof an aperture 159 corresponding generally to a shape of the second rotatable member 154.

As shown in FIG. 5A, a first outer bearing 156 rotatably secures the first rotatable member 134 to and/or within the assistive torque assembly 104. The first outer bearing 156 rotatably secures the first rotatable member 134 to, for example, an inside surface of the housing 130 of the assistive torque assembly 104. The second rotatable member 134 is rotatably attached to an inside surface of the housing 130 opposite the first outer bearing 156 by a second outer bearing 158.

An engagement ring 169 of the second rotatable member 154 is configured to extend exterior to and/or around an outer surface of the first rotatable member 134. The engagement ring 169 of the second rotatable member 154 extends radially outwardly to extend exterior to the outer surface of the first rotatable member 134 using an extension component 161. A center portion 155 of the second rotatable member 154 extends longitudinally within at least a portion of a thickness of the first rotatable member 134, such as through a central aperture 183, and is rotatably secured to an inside surface of and allowed to rotate relative to the first rotatable member 134 via one or more intermediate bearings 160. The first rotatable member 134 may be attached at an extension portion 165 thereof by one or more bearings 163 to the elastic element 140 via the first bracket assembly 142. The bearings 163 may define an aperture 177 within which the first pivot pin 146 may be received and within which the first pivot pin 146 may rotate.

As illustrated in FIGS. 5B and 5C, one or more protrusions 164 defined by or proximate an inner periphery of the engagement ring 169 of the second rotatable member 154 are configured to engage with one or more pawls 162 of the first rotatable member 134 at and/or beyond the predetermined flexion angle θ1 (FIG. 5B) and at and/or beyond the predetermined extension angle θ2 (FIG. 5C). The pawls 162 are arranged in an extended portion 157 of the first rotatable member 134, configured to correspond to the engagement ring 169. The extended portion 157 may, on at least a portion of the first rotatable member 134, extend into or be defined by the engagement portion 136.

This arrangement allows the first rotatable member 134 to engage the elastic mechanism 138 (see FIG. 4C) when the thigh link 106 and consequently the second rotatable member 154 are rotated beyond the predetermined flexion angle θ1 or the predetermined extension angle θ2. In embodiments, the protrusions 164 are configured in size and shape to contact one or more sides of the one or more pawls 162 of the first rotatable member 134. In the depicted embodiment, the one or more pawls 162 are arranged about the first rotatable member 134 in a substantially symmetric arrangement. The location and configuration of the pawls 162 and the protrusions 164 may be predetermined to facilitate predetermined ranges within which the operator can move freely and outside of which the elastic mechanism 138 is engaged.

As seen in FIG. 5B, showing a configuration corresponding to flexion of the thigh relative to the trunk, the first rotatable member 134 is rotatable relative to and engageable with the second rotatable member 154. In flexion, the second rotatable member 154 rotates relative to the first rotatable member 134 in a direction R_{Flex}. In contrast, in iperextension, the second rotatable member 154 rotates relative to the first rotatable member 134 in a direction Rₗₚₑᵣ.

In FIG. 5B, the pawls 162 are in an engagement configuration as opposed to a non-engagement configuration as will be described in greater detail herebelow. The engagement of the protrusions 164 of the second rotatable member 154 and the pawls 162 of the first rotatable member 134 determine the engagement of the elastic mechanism 138. The pawls 162 may be housed between side or wall segments 181, which may define a profile corresponding to the shape of the pawls 162, such as a curved profile corresponding to curved shapes of one or more corresponding sides of the pawls 162. The pawls 162 may be disposed between lower and upper surfaces of the extended portion 157 of the first rotatable member 134.

The pawls 162 may define distinct sides 171, 173 configured to engage corresponding and distinct sides of the protrusions 164. For example, a first side 171 may be curved to a greater degree than the second side 173. In embodiments, one of the first and second sides 171, 173 may define a profile corresponding to the curvature of the wall segments 181 such that in embodiments in which the pawls 162 are not protruding outwardly from the first rotatable member 134 i.e., the non-engagement configuration, the pawls 162 and the wall segments 181 define a substantially continuous and symmetrical outer surface of the first rotatable member 134.

In an engagement configuration, the pawls 162 thus may frictionally engage with the protrusions 164 such that any movement beyond the angle of engagement results in an assistive torque being provided by the elastic element 140. For example, a first side 171 of the pawls 162 may engage against the protrusion 164 to engage in further flexion. In contrast, the second side 173 may engage against the protrusion 164 to engage in further hyperextension or extension, as suitable. As the second rotatable member 154 continues to rotate, the engagement between the protrusions 164 and the pawls 162 causes further rotation of the first rotatable member 134 and loading of the elastic mechanism 138. Moreover, the further the first rotatable member 134 rotates upon engaging with the second rotatable member 154, the further the engagement portion 136 rotates away from the elastic mechanism 138 and the greater the loading of the elastic element 140.

One or both of the first and second sides 171, 173 may be configured to, upon being rotated by rotation of the selection shaft 166 into the engagement configuration shown in FIG. 5F, abut against a side wall 181. This advantageously arrests further rotation of the selection shaft 166, indicating to an operator that the engaged configuration has been reached. Alternatively, or in addition, the side walls 181 may be configured to contact the teeth 168 of the selection shaft 166 to arrest further rotation when the engagement configuration has been reached. The selection shaft 166 may, in embodiments, be rotated either to the left or the right to toggle the transparent range mechanism 152 from the non-engaged configuration to the engaged configuration and vice versa.

As shown in FIG. 5D, the transparent range mechanism 152 comprises a selection shaft 166 rotatable about the first axis of rotation I1 and operable by a free mode switch 122 to selectively disengage the one or more pawls 162 of the first rotatable member 134 to enable the second rotatable member 154 to rotate freely about the first rotatable member 134 without causing rotation of the first rotatable member 134 and, by consequence, without engaging the elastic mechanism 138 (see FIG. 4C).

The selection shaft 166 is substantially coaxial with the first and second rotatable members 134, 154 and extends within the central aperture 183. The selection shaft 166 may likewise define a central aperture 183 into which the center portion 155 of the second rotatable member 154 may extend. The free mode switch 122 may be secured to the selection shaft 166 by one or more fasteners 167 extending through an aperture in a flat portion 187 of the free mode switch 122 and into corresponding apertures in the selection shaft 166. The fasteners 167 may be any suitable fastener such as screws, pins, or otherwise. A ball plunger 200 is provided to stop the switch in a stable configuration, either in the engaged position or the disengaged position.

The selection shaft 166 may be configured to rotate relative to the second and/or first rotatable members 154, 134 using the intermediate bearings 160 and inner bearings 172, respectively. That is, the inner bearings 172 facilitate rotation of the selection shaft 166 relative to the second rotatable member 154, and the intermediate bearings 160 facilitate rotation of the selection shaft 166 relative to the first rotatable member 134, as will be discussed in greater detail herebelow.

The selection shaft 166 comprises one or more teeth 168 corresponding to the one or more pawls 162 of the first rotatable member 134 and configured to engage selectively and disengage the one or more pawls 162, wherein each of the one or more pawls 162 is rotatably secured to the first rotatable member 134 via a pivot pin 170. The pivot pin 170 advantageously extends into the upper and lower surfaces of the extended portion 157 of the first rotatable member 134. In embodiments, the one or more teeth 168 may correspond to a recess 175 defined in the pawls 162, for example in a non-engagement configuration. By contrast, in the engaged configuration, the rotation of the selection shaft 166 may rotate the teeth 168 out of the recesses 175 to pivot the pawls 162 out of continuous alignment with the outer surface of the first rotatable member 134. While the upper and lower surfaces of the extended portion 157 have been described, it will be appreciated that any suitable configuration, including an upper surface-only or lower surface-only attachment between the pawls 162 and the first rotatable member 134 may be utilized.

Rotation by an operator of the selection shaft 166 may cause the teeth 168 to press against an inner surface of the pawls 162 such that the pawls 162 pivot away from a default position in which a side of the pawl 162, which is configured to be substantially coextensive with the outer surface of the first rotatable member 134 and therefore does not protrude outwardly therefrom, shifts to a protruding position. That is, rotation of the selection shaft 166 pivots the pawls 162 from the non-engaged configuration to the engaged configuration.

The pawls 162, when not pressed outwardly from the outer surface or circumference of the first rotatable member 134 by the teeth 168 and are in the non-engagement configuration, do not engage the second rotatable member 154. When the pawls 162 are pressed outwardly to protrude from the outer surface of the first rotatable member 134 by the teeth 168 i.e., into the engagement configuration, the pawls 162 are configured to engage the second rotatable member 154 to rotate the first rotatable member 134 and consequently the elastic mechanism 138 to provide assistive torque outside the transparent range of the exoskeleton 100.

As seen in FIG. 5D, the selection shaft 166 is substantially disposed between the first and second rotatable members 134, 154, the one or more intermediate bearings 160 rotatably securing an outer surface of the selection shaft 166 to the inside surface of the first rotatable member 134. One or more inner bearings 172 rotatably secure an inside surface of the selection shaft 166 to an outside surface of the center portion 155 of the second rotatable member 154. Different arrangements of the location of the selection shaft relative to the first and second rotatable members may be modified accordingly and are within the scope of this application assuming the function and generally the same parts and the cooperation thereof remain the same.

FIG. 5E further illustrates the freedom of motion provided when the free mode switch 122 is operated to disengage the one or more pawls 162 of the first rotatable member 134, such that the second rotatable member 154 is completely uninhibited by the pawls 162 and thus is free to rotate about the first axis of rotation I1 without engaging the assistive torque assembly 104.

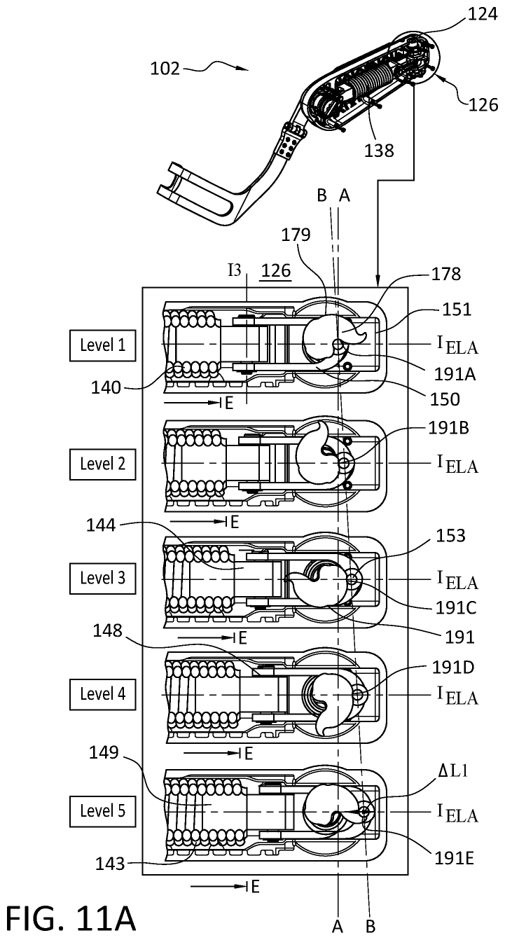

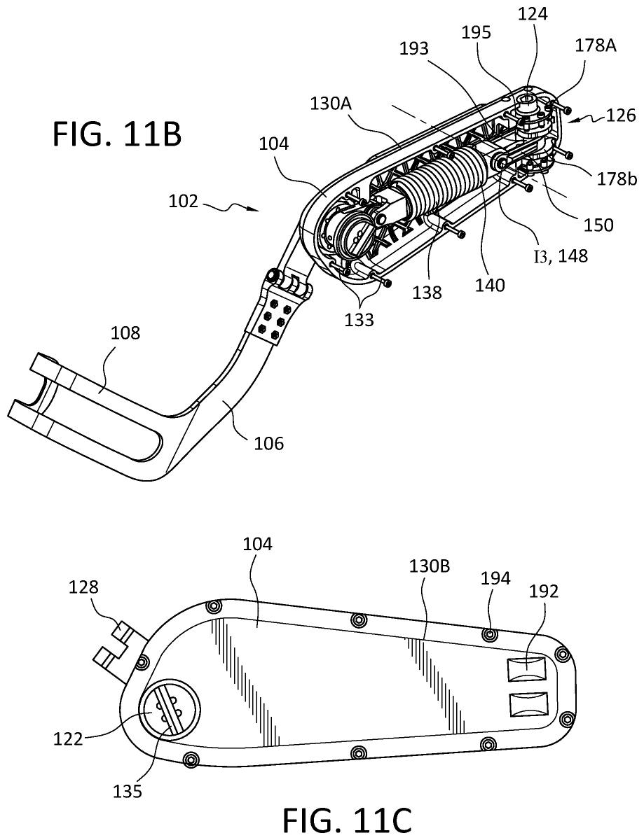

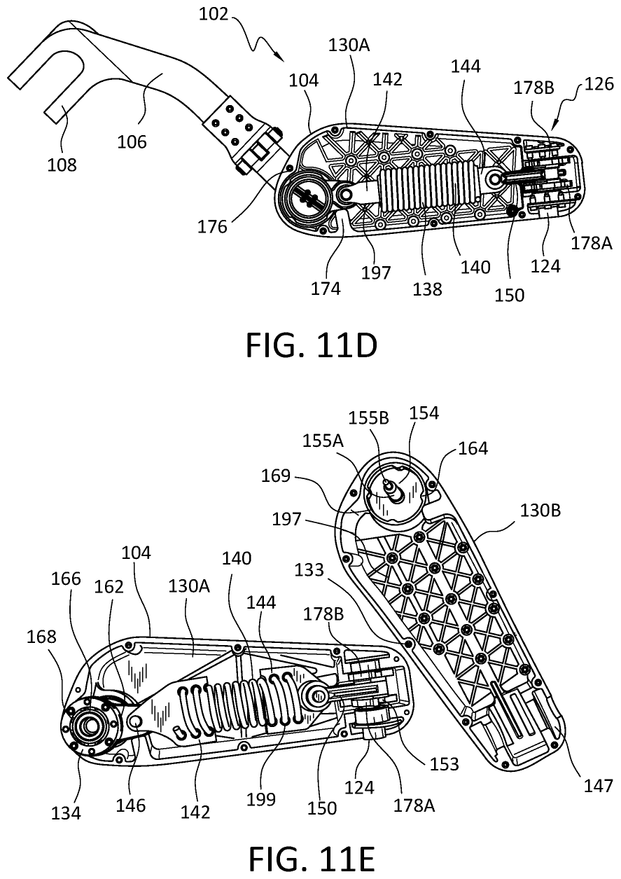

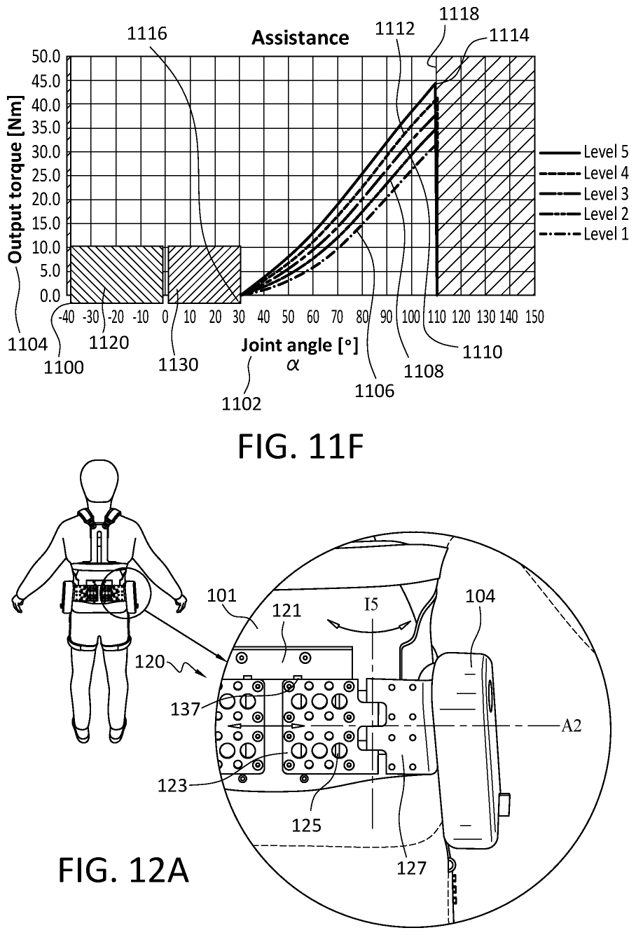

As illustrated in FIG. 5F, the one or more pawls 162 of the first rotatable member 134 are arranged to impose a predetermined flexion angle θ1 of 30° and a predetermined extension angle of −40°. It should be appreciated, however, that the relative placement of pawls 162 can be adjusted to impose a variety of predetermined flexion and extension angles θ1, 02 by embodiments of the present disclosure. The configuration of the predetermined flexion and extension angles facilitates a free range of extension up to 40° and a free range of flexion up to 30° without hindrance by engagement of the clastic mechanism 138. The range of extension and flexion may be selected based on a range of flexion and extension corresponding to normal walking degrees of flexion and extension. The free (i.e., non-engaged) ranges of extension 1120 and flexion 1130 are likewise shown in FIG. 11F.

FIG. 5G further illustrates the aforementioned functionality of the transparent range mechanism 152 with the free mode switch 122 engaged 502 to impose a limited range of motion on the operator and disengaged 504 to allow full freedom of motion. As seen, in the engaged mode 502, at differing degrees 506, 508, 510, the extension portion 165 extends at a different angle relative to the initial position. In contrast, in the disengaged mode, the extension portion 165 is unchanged from the initial position, allowing the operator to easily and effectively toggle between modes of operation, including a transparent mode in which the operator may complete certain activities without engagement of the torque assistance. A free mode in which the torque assistance is not provided, as suitable. As seen in FIG. 5H, when in the engaged mode 552, an assistance profile 562 of the exoskeleton does not provide any assistance between the initial position and 30°, assistance gradually increases from 30° to 110°, and may drop to zero beyond the maximum degree of extension/flexion, although a mechanical stop may impede movement of the link beyond such limit. In the disengaged mode 554, by contrast, the assistance profile 564 of the exoskeleton remains flat at all angles.

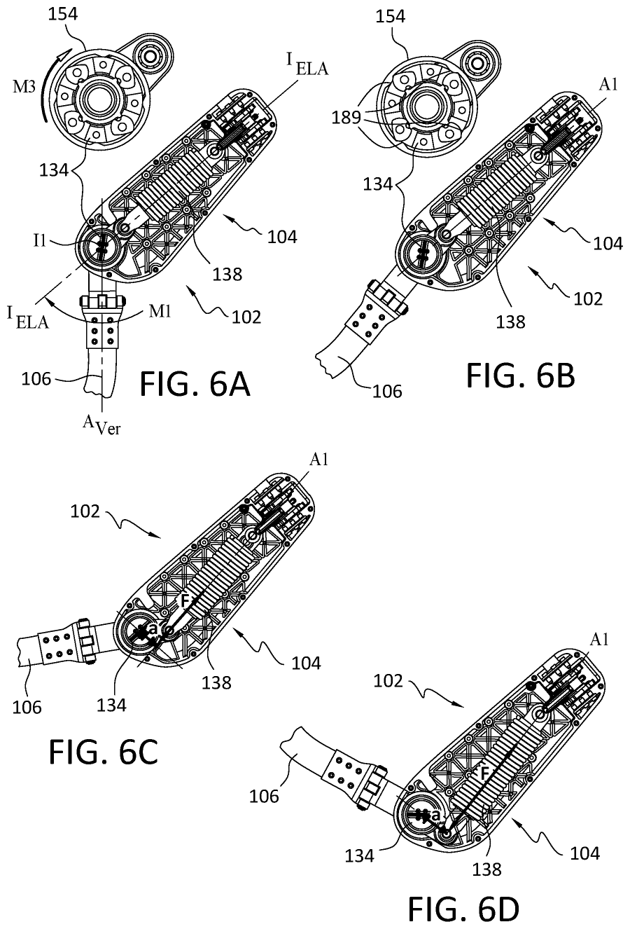

Referring to FIGS. 6A-6D, the compensation device 102 is secured to the operator such that the assistive torque assembly 104 is fixed relative to the hip joint of the operator and the thigh link 106 is fixed relative to the thigh of the operator. The compensation device 102 has an initial position corresponding to a standing position of the operator (the initial position corresponding to the position shown in FIG. 6A) with the thigh link 106 extending substantially vertically along a vertical axis Aver and the assistive torque assembly 104 extending offset from the vertical axis along which the thigh link 106 extends in the initial position. The axis I_{ELA} extends at an angle from the vertical axis Aver of the thigh link 106.

The angle at which the axis I_{ELA} extends at an angle from the vertical axis Aver may be determined based on any suitable factor, including a location of components arranged at the posterior of the exoskeleton 100, such as the degree-of-freedom chain 120. That is, the assistive torque assemblies 104 may extend upwardly as they extend posteriorly to accommodate the anatomy of an operator such that the degree-of-freedom chain 120 and other components are conveniently situated at or above the operator's lower back.

The predetermined angle of flexion θ1 and predetermined angle of extension θ2 (see FIG. 5F) are measured relative to the initial position such as shown in FIG. 6A. As discussed herein in reference to FIG. 4B, the thigh link 106 is configured to impart a moment M1 on or through the first axis of rotation I1 when the operator performs a squatting motion by bending at the knees such that rotates the thigh link 106 relative to the assistive torque assembly 104. The second rotatable member 154 is configured to rotate as a result of the moment M1, the second rotatable member 154 imparting a corresponding moment M3 on the first rotatable member 134 when an angle between the assistive torque assembly 104 and the thigh link 106, relative to the initial position, is greater than the predetermined angle of flexion θ1 such that the protrusions 164 of the second rotatable member 154 engage the pawls of the first rotatable member 134.

As seen in FIGS. 6A-6D, the thigh link 106 is connected through the second rotatable member 154, which engages the first rotatable member 134 through the engagement of the pawls 162 and the protrusions 154 as discussed above and causes rotation of the first rotatable member 134 in response to the operator's thigh movements during squatting (stooping), an exemplary pattern of which is shown in FIGS. 6A-6D. The rotation of the first rotatable member 134, moreover, effects the loading and unloading of the elastic mechanism 138 to impart an assistive torque about the hip joint.

The torque is generated according to Equation 1 below:

$$T = F * a \qquad ( 1 )$$

In Equation (1), T represents torque, F represents the spring force given by K*Δf, where K is the spring stiffness and AC is the spring elongation, and a represents the lever arm.

Whereas in FIG. 6A, the thigh link 106 is enabled to move through the transparent range without engaging the elastic mechanism 138, when the first rotatable member 134 is caused to rotate about the first axis of rotation I1 by the motion of the operator's thigh and/or trunk and according to the rotation of the second rotatable member 154 as shown in FIG. 6B, the first rotatable member 134 engages and elongates the clastic mechanism 138 and increases the spring force F and the lever arm a, such that a loading of the elastic mechanism 138 increases as the first end of the clastic mechanism 138 rotates about the first axis of rotation I1.

The engagement between the first and second rotatable members 134, 154 may occur at a plurality of contact points 189 between corresponding protrusions and pawls 164, 162. In the depicted embodiment four protrusions 164 and four corresponding pawls 162 yields four contact points 189, but it will be appreciated that more or fewer contact points 189 may be provided as suitable and are contemplated in the present disclosure. The loading of the elastic mechanism 138 imparts on the first axis of rotation I1 an assistive moment opposite the moment M1 caused by the squatting or bending motion to assist the operator in returning to the standing position.

The assistive moment increases as the first end 141 of the elastic mechanism 138 rotates about the first axis of rotation I1 to simultaneously increase: (i) the loading of the elastic mechanism 138 (the loading or spring force denoted as “F” in FIGS. 6C and 6D) and (ii) a moment or lever arm a defined by an orthogonal distance between the first axis of rotation I1 and a longitudinal axis I_{ELA} of the elastic mechanism 138 (the moment or lever arm denoted as “a” in FIGS. 6C and 6D). As the joint angle increases, the generated torque likewise increases until reaching a mechanical stop, which will be described in greater detail herein. Further, in embodiments, the lever arm a and the loading of the clastic mechanism 138 do not increase linearly as the joint angle increases due to the angular geometry of the rotation about the first rotatable member 134.

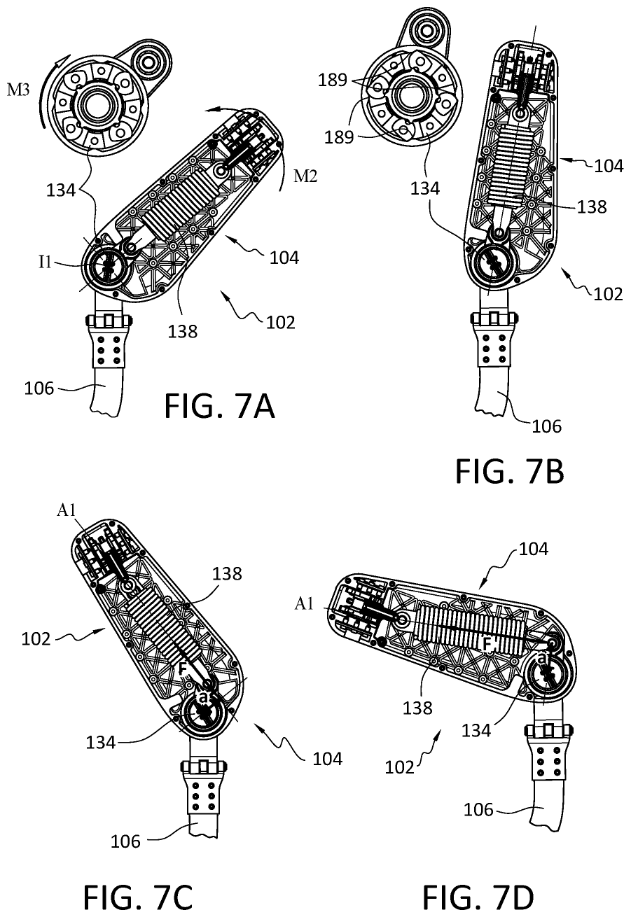

Referring to FIGS. 7A-7D, the compensation device 102 is secured to the operator such that the assistive torque assembly 104 is fixed relative to the hip joint of the operator and the thigh link 106 is fixed relative to the thigh of the operator. During use, such as during a stooping or bending-over motion, an exemplary pattern which is shown in FIGS. 7A-7D, the compensation device 102 has an initial position corresponding to a standing position of the operator (i.e., the initial position corresponding to the position shown in FIG. 7A in which the thigh link 106 extends substantially vertically with the assistive torque assembly offset from the vertical axis Aver along which the thigh link 106 extends in the initial position), wherein the predetermined angle of flexion 01 and the predetermined angle of extension θ2 (see FIG. 5F) are measured relative to the initial position.

As discussed herein in reference to FIG. 4B, the assistive torque assembly 104 is configured to impart a moment M2 on or through the first axis of rotation I1 when the operator performs a stooping motion by bending at the waist to rotate the assistive torque assembly 104 relative to the thigh link 106. The second rotatable member 154 rotates as a result of the moment M2. The second rotatable member 154 imparts a corresponding moment M3 on the first rotatable member 134 when an angle between the assistive torque assembly 104 and the thigh link 106, relative to the initial position, is greater than the predetermined angle of flexion θ1. The predetermined angle of flexion θ1 corresponds in embodiments to the predetermined transparent range.

When the first rotatable member 134 is caused to rotate about the first axis of rotation I1 beyond the predetermined angle of flexion θ1, the first rotatable member 134 engages and loads the elastic mechanism 138, such that a loading of the elastic mechanism 138 increases as the first end 141 of the elastic mechanism 138 rotates about the first axis of rotation I1.

As described above, the engagement between the first and second rotatable members 134, 154 may occur at a plurality of contact points 189 between corresponding protrusions and pawls 164, 162. In the depicted embodiment four protrusions 164 and four corresponding pawls 162 yield four contact points 189, but it will be appreciated that more or fewer contact points 189 may be provided as suitable and are contemplated in the present disclosure. The loading of the elastic mechanism 138 imparts on the first axis of rotation I1 an assistive moment opposite the moment M2 caused by the stooping motion to assist the operator in returning to the standing position.

The assistive moment increases as the first end 141 of the elastic mechanism 138 rotates about the first axis of rotation I1 to simultaneously increase: (i) the loading of elastic mechanism 138 (the loading or spring force denoted as “F” in FIGS. 7C and 7D and which increases from FIG. 7C to FIG. 7D) and (ii) a moment arm defined by an orthogonal distance between the first axis of rotation I1 and a longitudinal axis A1 of the elastic mechanism 138 (the moment or lever arm denoted as “a” in FIGS. 7C and 7D and which increases from FIG. 7C to FIG. 7D).

As the joint angle increases, the generated torque likewise increases until reaching a mechanical stop, which will be described in greater detail herein. A range of assistive torque may be provided between, for example, 30° and 110°, between the transparent range and a mechanically stopped range. Further, in embodiments, the lever arm a and the loading of the elastic mechanism 138 do not increase linearly as the joint angle increases due to the angular geometry of the rotation about the first rotatable member 134.

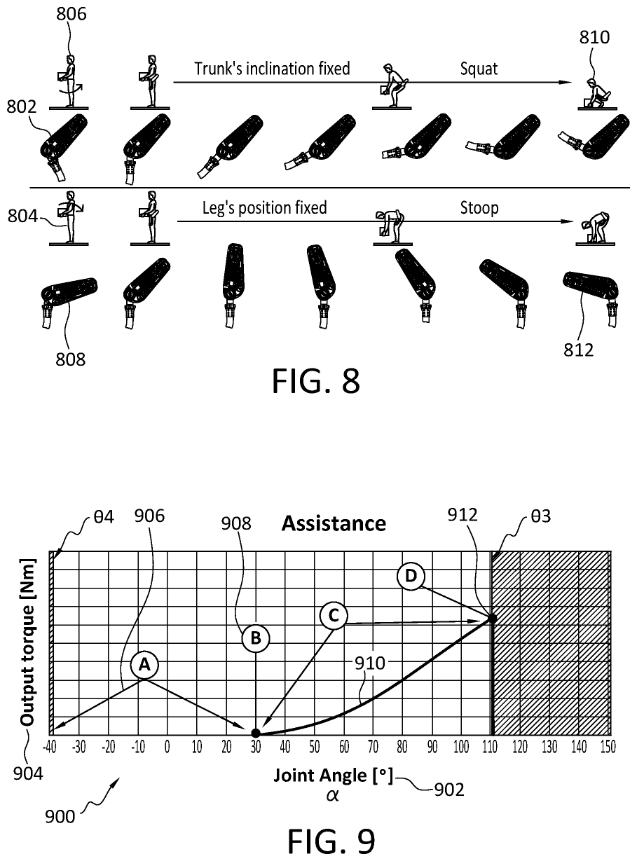

FIGS. 8 and 9 include additional illustrations for understanding the mechanics of compensation device 102 as the operator performs squatting and stooping motions. FIG. 8 shows a progression of the assistive torque device 104 and the thigh link 106 through both squatting 802 and stooping movements 804. The progression of motions extends from a standing position 806, 808 all the way to a full squat 810 and a full bend 812, with the configurations of the assistive torque assembly 104 and the thigh link 106 depicted at each motion throughout both squatting and bending.

As another example, FIG. 9 illustrates a plot 900 of exemplary output torques 904 (measured in Nm) of the assistive torque assembly 104 across a broad range of joint angles (a) 902 defined as the angle (measured in degrees) between thigh link 106 and assistive torque assembly 104 relative to the initial position (i.e., standing position) of the operator. In a first region A 906, corresponding to the transparent range, no assistive torque is provided up to an angle B 908 corresponding to the end of the transparent range A 906. In a second region C 910, assistive torque increases as a function of the joint angle until an angle D 912 is reached, after which point further assistance is not provided. This may be due to a mechanical stop as will be described in greater detail herebelow. The increase of the assistive torque in the second region C 910 may be linear or non-linear depending on the geometry of the assistive torque assembly 104.

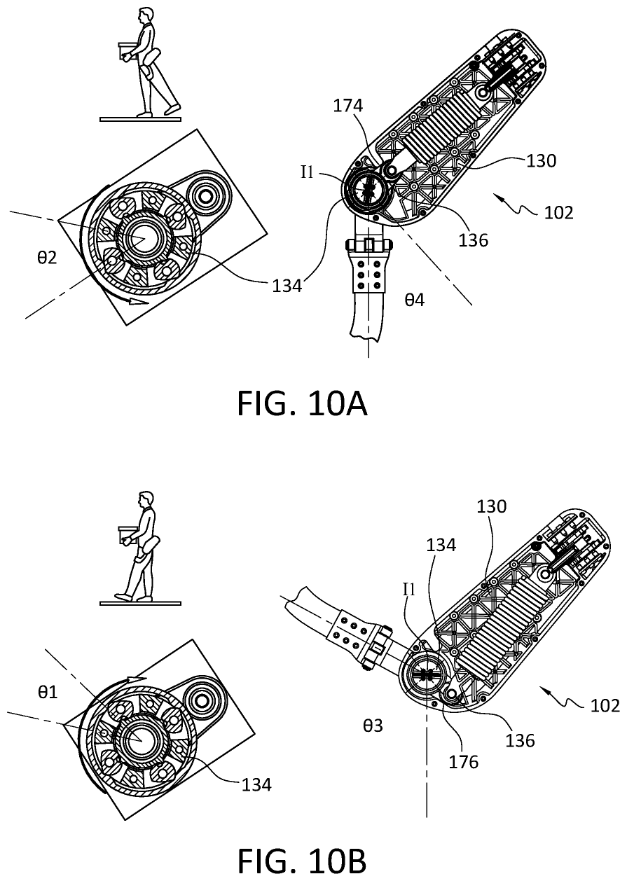

As illustrated by FIG. 10A, the compensation device 102 may comprise a first stop surface 174 defined by a surface of the housing 130 and configured to stop the engagement portion 136 of the first rotatable member 134 from rotating about the first axis of rotation I1 beyond an angle corresponding to a maximum angle of extension θ4, such that the compensation device 102 arrests the extension of the hip joint of the operator when the maximum angle of extension θ4 is reached relative to the initial position. For example, the maximum extension angle θ4 may be −40° relative to the initial position of the compensation device 102. However, one skilled in the art would appreciate that virtually any value of maximum angle of extension θ4 may be implemented in accordance with embodiments of the present disclosure.

As illustrated by FIG. 10B, the compensation device 102 may additionally or comprise a second stop surface 176 defined by the housing 130 and configured to stop the engagement portion 136 of the first rotatable member 134 from rotating about the first axis of rotation I1 beyond an angle corresponding to a maximum angle of flexion θ3, such that the compensation device 102 arrests the flexion of the hip joint of the operator when the maximum angle of flexion θ3 is reached relative to the initial position. For example, the maximum angle of flexion θ3 may be 110° relative to the initial position of the compensation device 102. However, one skilled in the art would appreciate that virtually any value of maximum angle of flexion θ3 may be implemented in accordance with embodiments of the present disclosure. Mechanically stopping the extension or flexion of the first rotatable member 134 determines a limit to the range in which assistive torque is provided to the operator.

The stop surfaces 174, 176 may be a removable stop surface configured to be swapped out and replaced to provide different maximum angles of extension and flexion without needing to change the entire housing 130. This advantageously allows different operators, e.g., subsequent shift operators, to customize the exoskeleton simply and effectively. In embodiments, the exoskeleton 100 may have different modes of operation requiring different maximum angles of flexion and extension, between which modes of operation the operator may simply toggle by swapping the removable stop surfaces. The removable stop surfaces may have any suitable material and configuration. In embodiments, the removable stop surfaces may be formed of a polymeric material, such as an elastomeric material.

The stop surfaces 174, 176 may be inserted through an aperture defined in or by the housing 130 from an exterior of the assistive torque assembly 104 such that the stop surfaces 174, 176 may be installed without disassembling the housing 130. In an embodiment, the housing 130 defines a dial or other feature for easily toggling between different stop surfaces defining different angles for mechanical stops. The housing 130, as seen in FIG. 11B, may comprise one or more plates or covers 130A configured to attach to one or more corresponding plates, covers, or bodies by one or more fasteners 133. The fasteners 133 may be any suitable component, including pins, studs, or otherwise and having any suitable configuration and material. In the depicted embodiment, two substantially symmetrical halves 130A of the housing 130 are joined using the fasteners 133.

FIG. 11A illustrates an embodiment of a compensation device 102 including an assistance regulation device 126 for adjusting the loading in the elastic mechanism 138. The assistance regulation device 126 comprises a cam 178 and a linkage assembly 150, with the linkage assembly 150 connected to the second end 143 of the elastic mechanism 138 by the second bracket assembly 142. The cam 178 may be configured to rotate about a fourth axis of rotation 14. The fourth axis of rotation 14 may be substantially transverse to the first axis of rotation I1 and/or the axis AELA of the assistive torque assembly 104.

The cam 178 comprises a surface profile 179 defining a plurality of predefined load settings for the assistance regulation device 126, said plurality of predefined load settings corresponding to variations ΔL1 shown in variations L1-L5 of the distance between the first and second ends 141, 143 of the elastic mechanism 138 in the standing position. The predefined load settings may adjust a distance ΔL1 between the linkage assembly 150 and a terminus 151 of the assistance regulation device 126, with the distance ΔL1 increasing for a lower tension or loading of the elastic mechanism 138 in the exoskeleton 100. In embodiments, the cam 178 comprises two separate cams 178A and 178B that rotate on opposite sides of the linkage assembly 150, as seen in FIG. 11B.

The cam is generally arranged to make possible the discrete selection of different degrees of extension of the spring to vary the mechanism's output torque. As can be observed from FIG. 11A, rotating the cam in a predetermined direction, such as counterclockwise, has the effect (evidenced by line A-A at a L1 and progressing according to line B-B for variations L2-L5) of moving one extremity away from the other, resulting in an extension E of the spring located in between.

The two separate cams 178A, 178B may have a same or corresponding configuration and may be connected to each other by a coupling part 193 extending between the separate cams 178A, 178B and configured to correspond to and/or cooperate with an inner surface of the linkage assembly 150. The cams 178A, 178B may be secured relative to the housing 130 by one or more connection components 195, which may secure at or through the housing 130 and permit rotation of the cams 178A, 178B relative thereto.

The cam 178 is part of a cam assembly comprising the cam 178 and an attached bracket 144 that connects to a spring mount 149 that supports or is secured to the second end 143 of the clastic mechanism 138. As the cam 178 is rotated between one of the pluralities of predefined features, which may be recesses or detents 191 configured to receive, for example, a pin 153 of the linkage assembly 150, the cam assembly is configured to move the bracket 144 and accordingly the spring mount 149 within the assistive torque assembly 104 housing 130 relative to the first end 141 of the clastic mechanism 138. The pin 153 may extend through a thickness of the linkage assembly 150 to engage both of the cams 178A, 178B. The recesses or detents 191 advantageously define an equilibrium point within which the pin 153 may stably rest at the set load level. The separate cams 178A, 178B may rotate simultaneously such that the pin 153 engages a same recess 191 in both of the separate cams 178A, 178B. In the depicted embodiment, a recess 191A, 191B, 191C, 191D, 191E corresponds respectively to each of the levels L1-L5, but more or fewer recesses and levels may be provided.

For instance, by rotating the cam 178 to a higher setting corresponding to, for example, level 3 rather than level 2 as shown in FIG. 11A, the length L1 of the elastic mechanism 138 in the standing configuration is elongated relative to the length L1 in the standing configuration at level 2. This facilitates providing a greater degree or amount of assistive torque during the same movements by the operator in level 3 compared to level 2. The cam 178 hereby provides different levels of assistive force selectable by the operator. Further, by providing the recesses or detents 191, the operator may apply a torque to the cam assembly to move the cams 178A, 178B such that the pin 153 rotates from a local minimum defined by one of the recesses 191A, 191B, 191C, 191D, 191E and over the corresponding local maximum to the next recess.

As shown, an assistance selection dial 124 is connected to the cam 178 such that the plurality of predefined load settings of the cam 178 are manually adjustable by rotation of the assistance selection dial 124 by the operator. The linkage assembly 150 is configured to linearly move about the longitudinal axis I_{ELA} of the elastic mechanism 138 according to rotation of the assistance selection dial 124 and the cam 178 to adjust the loading in the elastic mechanism 138. The cam 178 may have an asymmetrical surface profile 179 and/or operation according to the cam and cam assembly of U.S. patent application publication no. 2020/0139537, filed Jun. 19, 2018, and incorporated herein in its entirety by reference.

The provision of predefined tension settings advantageously allows an operator to determine a desired load setting simply and accurately for assistance regulation devices 126 on both sides of an exoskeleton 100. For instance, the operator can easily toggle the assistance regulation devices 126 on both left and right sides of the exoskeleton to a same load setting.

In an embodiment, the assistance selection dial 124 is accessible by the operator through an aperture defined through a thickness of the housing 130. As the cam 178 is rotatable about the axis 14, the aperture may be defined in a surface of the housing 130 substantially transverse to the opening through which the free mode switch 122 is accessible. In embodiments, the assistance selection dial 124 faces upward or downward while the free mode switch 122 faces outward or inward. While this configuration has been described, it will be appreciated that any suitable configuration of the components may be utilized, and the disclosure is not limited to the depicted embodiments.

Turning now to FIG. 11C, a cover 130B of the housing 130 is depicted. The cover 130B may have a substantially smooth outer surface for comfort, aesthetic appeal, and a minimized profile. The free mode switch 122 defines a grip portion 135 allowing the operator to toggle between the engaged and non-engaged modes easily. Indicia may be provided on the surface of the cover 130B to help the operator discern when the engaged mode vs. the non-engaged mode is activated by the position of the free mode switch 122. The cover 130B may also define one or more protrusions 192 configured to accommodate the cams 178A, 178B and to facilitate rotation thereof within the assistive torque assembly 104. Recesses 194 allow for the insertion of the fasteners 133 without protruding from a surface of the cover 130B. An inner surface of the covers 130A, 130B of the housing 130 may define a pattern of ribs 197. The ribs 197 may comprise raised portions of the cover 130A, 130B facilitating increased structural strength without contributing significantly to the weight of the exoskeleton 100.

As shown in FIG. 11D, the assistive torque assembly 104 is shown in cutaway plan view. The linkage assembly 150 extends around a coupling part 193 with rotation of the cams 178A, 178B serving to adjust a length of the elastic element 140 between first and second ends thereof. The first rotatable member 134 in cooperation with the second rotatable member 154, adjust a tension in the elastic mechanism 138 depending on the angle between the operator's thigh and trunk. Mechanical stops 174, 176 arrest rotation beyond a predetermined maximum degree by contacting the extension portion 136.

Turning now to FIG. 11E, an assistive torque assembly 104 according to an embodiment is shown in a disassembled configuration. The housing 130 comprises two covers 130A, 130B configured to be joined along a longitudinal joint and circumscribe the components of the assistive torque assembly 104. The covers 130A, 130B may define recesses 147 configured to receive and cooperate with components such as the cams 178A, 178B. In the embodiment of FIG. 11E, the elastic mechanism 138 comprises an elastic element or wire 140 attached to the first and second brackets 142, 144 and configured to receive tension therein, such as by elongating under work performed by the first and second rotatable members 134, 154 as the operator's thigh rotates relative to the operator's trunk and vice versa.

The elastic element 140 may be secured to the first and second brackets 142, 144 in any suitable manner, such as by being threaded through one or more apertures 199. A plurality of apertures 199 may be provided in the brackets 142, 144 to allow for variability of assistive torque provided. By threading the elastic element 140 through different apertures 199, more or less tension may be provided in the elastic mechanism 138 in a standing configuration. A combination of clastic elements 140 may be used as suitable, such as to provide redundancy or increased tension in the assistive torque assembly 104.

As shown, the second rotatable member 154 may be secured within or to the cover 130B and configured to rotate relative thereto based on the movement of the thigh link 106. The second rotatable member 154 comprises an engagement ring 169 defining on an inner surface thereof a plurality of teeth 164 that engage corresponding pawls 162 to rotate the first rotatable member 134. The second rotatable member 154 comprises a center portion comprising distinct first 155A and second 155B parts, with the second part 155B having a reduced diameter relative to the first part 155A from which the second part 155B extends. This allows the second rotatable member 154 to accommodate the rotation of the first rotatable member 134 and the selection shaft 166 in a coaxial arrangement about the first axis of rotation I1.

FIG. 11F illustrates a plot 1100 of exemplary output torques 1104 as a function of joint angle (α) 1102 according to the various exemplary operational configurations shown in FIG. 11A. As illustrated, the output torque 1104 produced by assistive torque assembly 104 increases as the distance L1 between the first and second ends of the elastic mechanism 138 is increased by rotation of the cam 178. L1 has a torque profile 1106, L2 has a torque profile 1108, L3 has a torque profile 1110, L4 has a torque profile 1112, and L5 has a torque profile 1114. Each of the torque profiles 1106, 1108, 1110, 1112, 1114 may increase from the end 1116 of the transparent range toward the mechanically stopped angle 1118 at different levels of torque corresponding to an operator's individual needs and activities.

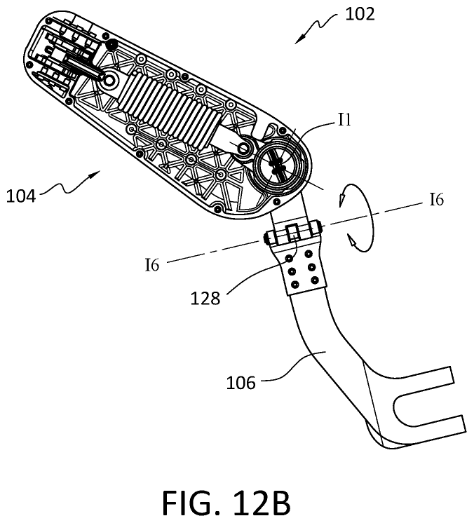

FIG. 12A shows an embodiment of degree-of-freedom chain 120, wherein the at least one degree of freedom comprises rotation about a fifth axis of rotation 15 proximate to the assistive torque assembly 104 and oriented in a substantially vertical direction when the operator is standing upright. As shown, the at least one degree of freedom provided by the degree-of-freedom chain 120 also comprises lateral movement along a lateral axis A2 spanning a posterior side of the waist belt 112. Various solutions are presently available for providing a degree-of-freedom chain as illustrated and described herein. For example, one such apparatus is described in U.S. Pat. No. 10,603,242, granted Mar. 31, 2020 to Vitiello et. al and incorporated herein in its entirety by reference.

For example, the degree-of-freedom chain 120 may be mounted on or cooperate with a back plate 101 and may comprise or define a plate 123 comprising one or more apertures 125. The back plate 101 may be integral with or connected to the back brace 116. The plate 123 attaches to a supporting plate 127 secured to the housing 130 of the compensation device 102. The one or more apertures 125 may be configured to receive a fastener 137 for securing the plate 123 to a track 121. The apertures 125 may further reduce a weight and cost of the exoskeleton 100 without sacrificing needed structural strength and functionality.

The fastener 137 may be any suitable fastener, such as a screw, pawl and ratchet assembly, a magnetic component, combinations thereof, or any other suitable component. The degree-of-freedom chain 120 may be configured to translate the supporting plate 127 for compensation devices 102 on either side of the exoskeleton 100 independently or dependently, such that an operator may adjust each compensation device's 102 position individually. In embodiments, the operator may make a single adjustment to position both supporting plates 127 at a desired width to accommodate the operator's dimensions. The degree-of-freedom chain 120 further advantageously transmits assistive torques generated by the assistive torque assemblies 104 to the trunk of the operator via the back plate 101. In embodiments, the fastener 137 serves to secure the degree-of-freedom chain 120 components relative to the operator such that in use, the forces generated by the exoskeleton 100 are readily transmitted to the operator's body.

FIG. 12B shows an embodiment of the compensation device 102, wherein the connection element 128 rotatably secures the thigh link 106 to the assistive torque assembly 104 to enable the thigh link 106 to pivot about a sixth axis of rotation 16, thus providing an additional degree of freedom to the thigh of the operator. As illustrated, rotation of the thigh link 106 about the sixth axis of rotation 16 is substantially orthogonal to rotation of the thigh link 106 about the first axis of rotation I1. This facilitates abduction and adduction and accommodates the different dimensions and activities of different operators.

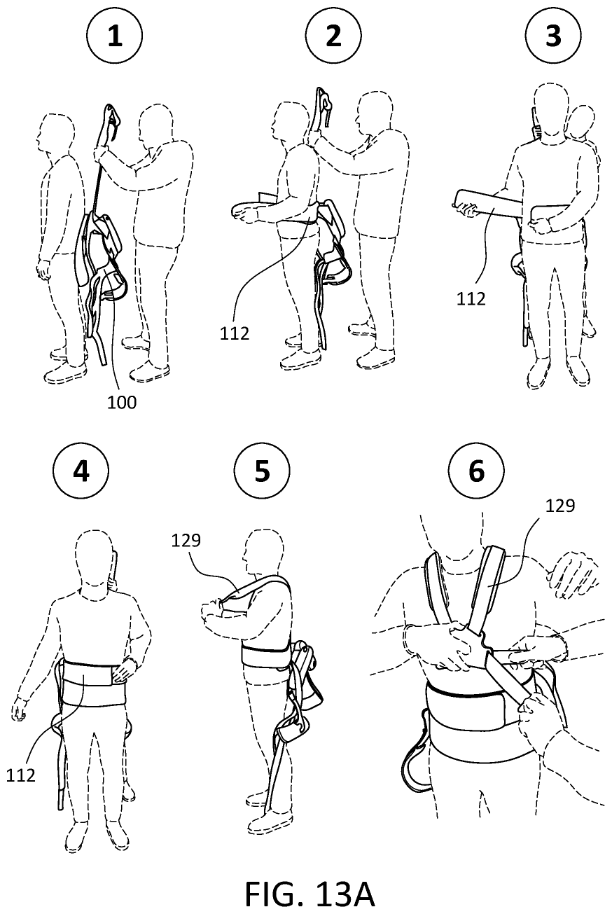

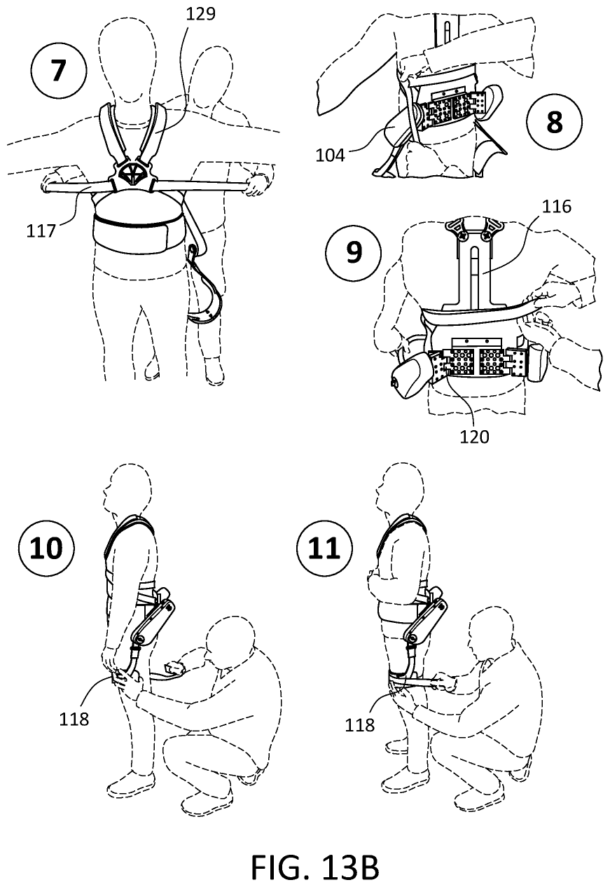

FIG. 13A-13B show an embodiment of the exoskeleton 100, wherein the human-machine interface 110 is configured to be secured to the operator by the following steps: (1)-(4) securing the waist belt 112 about a waist of the operator, such that degree-of-freedom chain 120 is associated with a lumbar of the operator above the hip joints of the operator; (5)-(7) securing the upper body harness 114 about a torso of the operator, such that the back brace 116 is aligned with a spine of the operator; (8)-(9) securing one or more excess straps of human-machine interface 110 to prevent interference with compensation device 102; and (10)-(11) associating the first axis of rotation I1 of the assistive torque assembly 104 with the hip joint of the operator and securing the thigh cuff 108 to a thigh of the operator with the thigh strap 118.

As illustrated in FIGS. 1, 2A-2C, and 13A-B, the exoskeleton 100 may comprise first and second compensation devices 102, the first compensation device 102 configured to compensate for resistive moments acting on a first hip joint of the operator and the second compensation device 102 configured to compensate resistive moments acting on a second hip joint of the operator.

Despite depicting a passive lumbar exoskeleton, it will be appreciated that the embodiments may be utilized in a powered exoskeleton. For example, an exoskeleton according to the depicted embodiments may comprise a power source, one or more actuators, and/or a controller configured to provide an assistive torque to an operator corresponding to the angle between the thigh and the trunk, with a transparent range of motion in which no assistive torque is provided, and/or with different levels of actuation as described herein. Accordingly, the embodiments are not limited to a passive exoskeleton, but rather extend equally to a powered exoskeleton.

Further, despite depicting a lumbar exoskeleton, it will be appreciated that the embodiments may be applied equally to other joints. For example, the assistive torque assemblies and components thereof, including the transparent range mechanism and the assistance regulation device, may be applied to any suitable joint of the body and in any suitable configuration.

According to the disclosed embodiments, the problems of existing exoskeletons being difficult to adjust to specific uses and operator needs are addressed by providing an exoskeleton, including a passive lumbar exoskeleton. The exoskeleton embodiments of the disclosure advantageously provide improved adjustability of the exoskeleton, including defining a transparent range in which normal activities may be performed without using assistive torque from the exoskeleton, and outside of which assistive torque may be utilized in a desired level that an operator may simply and effectively specify even for a passive exoskeleton device.

It is to be understood that not necessarily all objects or advantages may be achieved under an embodiment of the disclosure. Those skilled in the art will recognize that the exoskeletons and methods for making the same may be embodied or carried out in a manner that achieves or optimizes one advantage or group of advantages as taught herein without achieving other objects or advantages as taught or suggested herein.

The skilled artisan will recognize the interchangeability of various disclosed features. Besides the variations described herein, other known equivalents for each feature can be mixed and matched by one of ordinary skill in this art to construct an exoskeleton and utilize a method for making the same under principles of the present disclosure. The skilled artisan will understand that the features described herein may be adapted to other types of passive, pseudo-passive, or active assistive exoskeletons.

Although this disclosure describes certain exemplary embodiments and examples of a passive lumbar exoskeleton, it will be understood by those skilled in the art that the present disclosure extends beyond the specifically disclosed passive lumbar exoskeleton embodiments to other alternative embodiments and/or uses of the disclosure and obvious modifications and equivalents thereof. It is intended that the present disclosure should not be limited by the disclosed embodiments described above and may be extended to other applications that may employ the features described herein.

1.-20. (canceled)

21. An assistive torque assembly configured to produce an assistive torque about at least one joint of an operator, the assistive torque assembly comprising:
at least one elastic mechanism;
a transparent range mechanism configured to define a free range in which the operator may move without engaging the at least one elastic mechanism; and
an assistive regulation device configured to determine a level of assistive torque provided by the at least one elastic mechanism;
wherein the assistive torque assembly comprises a housing and a thigh link;
wherein the transparent range mechanism comprises a first rotatable member comprising an extension portion configured to rotatably attach to a first bracket.

22. The assistive torque assembly of claim 21, wherein the at least one elastic mechanism provides the assistive torque dependent on an angle of the at least one joint.

23. The assistive torque assembly of claim 21, wherein the thigh link comprises a thigh cuff configured to attach about a thigh of the operator.

24. The assistive torque assembly of claim 21, wherein the housing comprises at least one cover configured to circumscribe one or more components of the assistive torque assembly.

25. The assistive torque assembly of claim 24, wherein the first bracket is attached to a first end of the at least one elastic mechanism, the first bracket rotatably attaching to the extension portion by a first pivot pin.

26. The assistive torque assembly of claim 24, wherein the transparent range mechanism further comprises a second rotatable member coaxially arranged with the first rotatable member and attached to the thigh link.

27. The assistive torque assembly of claim 26, wherein the transparent range mechanism further comprises a free mode switch secured to a selection shaft, the selection shaft coaxially arranged with the first and second rotatable members.

28. The assistive torque assembly of claim 27, wherein the selection shaft defines one or more protrusions on an outer surface thereof.

29. The assistive torque assembly of claim 27, wherein the first rotatable member comprises one or more pawls pivotally arranged proximate an outer surface thereof;
wherein the second rotatable member comprises an engagement ring defining one or more protrusions on an inner surface thereof.

30. The assistive torque assembly of claim 29, wherein the one or more pawls are configured to correspond to the one or more protrusions of the engagement ring, the engagement ring extending about the first rotatable member.

31. The assistive torque assembly of claim 29, wherein the transparent range mechanism defines an engaged configuration in which the one or more protrusions of the engagement ring contact the one or more pawls and facilitate simultaneous rotation of the second rotatable member and the first rotatable member;
wherein the transparent range mechanism defines a non-engaged configuration in which the one or more protrusions of the engagement ring do not contact the one or more pawls such that the second rotatable member freely rotates about and relative to the first rotatable member.

32. The assistive torque assembly of claim 31, wherein the transparent range mechanism is configured to be toggle between the engaged and non-engaged configurations by the free mode switch being rotated such that the one or more protrusions of the selection shaft pivot the one or more pawls out of the non-engaged configuration.

33. The assistive torque assembly of claim 31, wherein in the non-engaged configuration, a surface of the one or more pawls extends substantially continuously with an outer surface of the first rotatable member;
wherein in the non-engaged configuration, the one or more protrusions of the selection shaft extend into one or more corresponding recesses defined in the one or more pawls.

34. The assistive torque assembly of claim 29, wherein the one or more protrusions of the engagement ring and/or the one or more pawls of the first rotatable member are arranged to define a predefined flexion angle and a predefined extension angle beyond which the second rotatable member engages and rotates the first rotatable member.

35. An assistive torque assembly configured to produce an assistive torque about at least one joint of an operator, the assistive torque assembly comprising:
at least one elastic mechanism;
a transparent range mechanism configured to define a free range in which the operator may move without engaging the at least one elastic mechanism; and
an assistive regulation device configured to determine a level of assistive torque provided by the at least one elastic mechanism;
wherein the assistive regulation device comprises one or more cams defining a profile and a plurality of recesses corresponding to a plurality of levels of assistive torque.

36. The assistive torque assembly of claim 35, wherein the one or more cams are configured to be rotatable by a dial between the plurality of levels of assistive torque.

37. The assistive torque assembly of claim 35, wherein a second end of the at least one elastic mechanism is attached to a second bracket;
wherein the second bracket is attached to a linkage assembly defining a pin cooperating with the plurality of recesses of the one or more cams.

38. The assistive torque assembly of claim 37, wherein the assistive regulation device is configured to change a length of the at least one elastic mechanism by rotating the one or more cams, the rotation of the one or more cams translating the linkage assembly away from the transparent range mechanism.

39. An assistive torque assembly configured to produce an assistive torque about at least one joint of an operator, the assistive torque assembly comprising:
at least one elastic mechanism;
a transparent range mechanism configured to define a free range in which the operator may move without engaging the at least one elastic mechanism; and
an assistive regulation device configured to determine a level of assistive torque provided by the at least one elastic mechanism;
a housing arranged to be secured to an operator and to be held stationary concerning the joint when worn by the operator;
a thigh link rotatable about a first axis of rotation corresponding to an operator's joint, the thigh link having a high cuff arranged to engage an operator's thigh to produce resistive moments about the first axis of rotation;
a first rotatable member arranged to be brought into relative motion about the first axis of rotation due to movement of the joint of the operator, the first rotatable member having an engagement portion, an elastic mechanism attaching at a first end to the engagement portion of the first rotatable member;
a second rotatable member arranged relative to the first rotatable member such that the first and second rotatable members are mutually rotatable about the first axis of rotation;
wherein the second rotatable member is secured to the thigh link and is configured to engage the first rotatable member and the elastic mechanism attached to it when the thigh link is rotated to a predetermined flexion angle and a predetermined extension angle relative to the assistive torque assembly.

40. The assistive torque assembly of claim 39, wherein the second rotatable member includes one or more protrusions configured to engage with one or more pawls of the first rotatable member at the predetermined flexion angle or the predetermined extension angle, such that the first rotatable member engages the elastic mechanism when the thigh link is rotated beyond the predetermined flexion angle or the predetermined extension angle.
